(19) United States
(12) Patent Application Publication
(10) Pub. No.: US 2026/0348131 A1
(43) Pub. Date: Nov. 5, 2026

(54) Work Machine

(71) Applicant: Hitachi Construction Machinery Co., Ltd., Taito-ku, Tokyo (JP)

(72) Inventors: Seiji HIJIKATA, Tsuchiura-shi (JP); Kenji HIRAKU, Tsuchiura-shi (JP); Tsuyoshi YAMADA, Tsuchiura-shi (JP)

(21) Appl. No.: 19/487,542

(22) PCT Filed: Apr. 18, 2024
(86) PCT No.: PCT/JP2024/015453

§ 371 Date: Nov. 25, 2025

(30) Foreign Application Priority Data
May 26, 2023 (JP) 2023-087007

(51) Int. Cl. E02F 9/22; E02F 9/20; F15B 11/02; F15B 11/17; F15B 19/00

(52) U.S. Cl. CPC E02F 9/2203; E02F 9/2004; E02F 9/2217; E02F 9/2292; F15B 11/02; F15B 11/17; F15B 19/00; F15B 2211/857

(57) ABSTRACT

A work machine includes: a work device; a first electrically driven motor that drives a first hydraulic pump that supplies hydraulic operating fluid to a high pressure line; a second electrically driven motor that drives a second hydraulic pump that supplies the hydraulic operating fluid to a low pressure line; a hydraulic cylinder that has four chambers, and drives the work device by being driven by the hydraulic operating fluid delivered from the first hydraulic pump and the second hydraulic pump; high pressure control valves that control communication and interruption between the high pressure line and the chambers; low pressure control valves that control communication and interruption between the low pressure line and the chambers; pressure sensors that sense pressures of the chambers; an operation amount sensor that senses an operation amount of an operation device that operates the hydraulic cylinder; and a controller that controls the high pressure control valves and the low pressure control valves on the basis of sensing results of the pressure sensors and the operation amount sensor, and controls the rotational speed of the first electrically driven motor on the basis of the sensing result of the operation amount sensor.

### TECHNICAL FIELD

The present invention relates to a work machine.

### BACKGROUND ART

A multi-chamber cylinder having a plurality of chambers is known as a hydraulic actuator for driving a work device of a work machine such as a hydraulic excavator (see Patent Document 1). Patent Document 1 discloses a hydraulic drive system including: a high pressure accumulator connected to a high pressure line; a low pressure accumulator connected to a low pressure line; and a plurality of control valves that control a flow of hydraulic operating fluid supplied from each of the high pressure line and the low pressure line to the multi-chamber cylinder.

This hydraulic drive system can drive the multi-chamber cylinder while suppressing a pressure loss, by controlling the plurality of control valves and thereby connecting each of the plurality of chambers to the high pressure line or the low pressure line.

### PRIOR ART DOCUMENT

### Patent Document

Patent Document 1: WO-2010/040890-A

### SUMMARY OF THE INVENTION

### Problem to be Solved by the Invention

In the hydraulic drive system described in Patent Document 1, the high pressure accumulator holds the pressure of the high pressure line constant. There is thus room for an improvement from a viewpoint of a pressure loss that occurs in the control valves when the multi-chamber cylinder is driven.

It is an object of the present invention to provide a work machine that can further reduce the pressure loss that occurs when a hydraulic cylinder is driven.

### Means for Solving the Problem

A work machine according to one aspect of the present invention includes: a machine body; a work device attached to the machine body; a first hydraulic pump that supplies hydraulic operating fluid to a high pressure line; a first power source that drives the first hydraulic pump; a second hydraulic pump that supplies the hydraulic operating fluid to a low pressure line; a second power source that drives the second hydraulic pump; a hydraulic cylinder that has four chambers, and drives the work device by being driven by the hydraulic operating fluid delivered from the first hydraulic pump and the second hydraulic pump; four high pressure control valves that control communication and interruption between the high pressure line and the four chambers of the hydraulic cylinder; four low pressure control valves that control communication and interruption between the low pressure line and the four chambers of the hydraulic cylinder; four pressure sensors that sense pressures of the four chambers; an operation device that operates the hydraulic cylinder; an operation amount sensor that senses an operation amount of the operation device; and a controller that controls the four high pressure control valves and the four low pressure control valves on the basis of sensing results of the pressure sensors and the operation amount sensor. The first power source and the second power source are electrically driven motors. The controller controls a rotational speed of the electrically driven motor as the first power source on the basis of the sensing result of the operation amount sensor.

### Advantages of the Invention

The present invention can provide a work machine that can further reduce the pressure loss that occurs when a hydraulic cylinder is driven.

### BRIEF DESCRIPTION OF THE DRAWINGS

FIG. 1 is a side view of a hydraulic excavator 10 according to a first embodiment.

FIG. 2 is a schematic diagram of a hydraulic system 106 provided to the hydraulic excavator 10.

FIG. 3 is a configuration diagram of the hydraulic system 106 according to the first embodiment, and illustrates details of a hydraulic cylinder 1, a control valve unit 150, a first hydraulic fluid source 101, and a second hydraulic fluid source 100.

FIG. 4 is a diagram of a hardware configuration of a controller 140.

FIG. 5 is an index table of assistance in explaining sixteen patterns of connections of the hydraulic cylinder 1.

FIG. 6 is a diagram illustrating relation between a load pressure and a load flow rate of the hydraulic cylinder 1.

FIG. 7 is a characteristic diagram of the hydraulic cylinder 1.

FIG. 8 is a functional block diagram of the controller 140 according to the first embodiment.

FIG. 9 is a flowchart illustrating a flow of processing of valve control by a valve control section 152.

FIG. 10 is a diagram of assistance in explaining processing of computing an HP demanded flow rate by a demanded flow rate computing section 153.

FIG. 11 is a diagram of assistance in explaining processing of computing a target rotational speed of a first electrically driven motor 17 by a rotational speed computing section 154.

FIG. 12 is a diagram of assistance in explaining processing of computing an LP demanded flow rate by the demanded flow rate computing section 153.

FIG. 13 is a diagram of assistance in explaining processing of computing a target rotational speed of a second electrically driven motor 14 by the rotational speed computing section 154.

FIG. 14 is a functional block diagram of a controller 240 according to a second embodiment.

FIG. 15 is a flowchart illustrating a flow of processing of computing a suction flow rate by a demanded flow rate computing section 253.

FIG. 16 is a diagram illustrating a configuration of hydraulic fluid sources according to a third embodiment.

FIG. 17 is a diagram illustrating a configuration of hydraulic fluid sources according to a fourth embodiment.

FIG. 18 is a diagram illustrating a configuration of hydraulic fluid sources according to a fifth embodiment.

FIG. 19 is a control block diagram of a rotational speed computing section 554 according to the fifth embodiment.

FIG. 20 is a diagram illustrating a configuration of hydraulic fluid sources according to a sixth embodiment.

### MODES FOR CARRYING OUT THE INVENTION

Work machines according to embodiments of the present invention will be described with reference to the drawings. In the present embodiments, a description will be made of an example in which the work machines are a crawler type hydraulic excavator. The work machines perform work such as civil engineering work, construction work, demolition work, or dredging work on a work site.

### First Embodiment

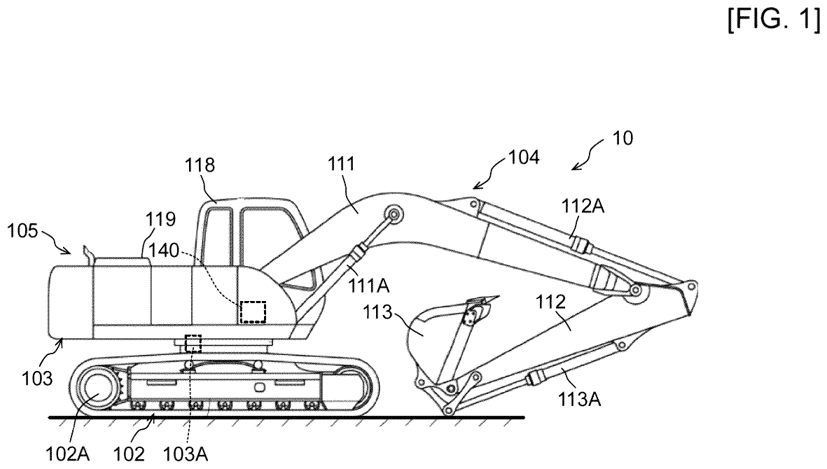

FIG. 1 is a side view of a hydraulic excavator 10 according to a first embodiment. As illustrated in FIG. 1, the hydraulic excavator 10 includes a machine body 105 and a work device 104 that is attached to the machine body 105. The machine body 105 includes a crawler type track structure 102 and a swing structure 103 swingably provided on the track structure 102. The track structure 102 travels by a pair of left and right crawlers being driven by travelling motors 102A. The swing structure 103 is coupled to the track structure 102 via a swing device including a swing motor 103A, and swings with respect to the track structure 102 by being driven by the swing motor 103A.

The swing structure 103 has a cab 118 to be boarded by an operator and a machine room 119 that houses prime movers and hydraulic equipment. The machine room 119 houses, for example, electrically driven motors as the prime movers and the hydraulic equipment such as hydraulic pumps driven by the electrically driven motors.

Provided within the cab 118 is an electric operation device for operating hydraulic actuators (111A, 112A, 113A, 103A, and 102A) of the work device 104, the swing structure 103, and the track structure 102. Also provided within the cab 118 is a controller 140, which is a controller that controls the operation of various parts of the hydraulic excavator 10.

The work device 104 is an articulated type work device attached to the swing structure 103. The work device 104 includes a plurality of hydraulic actuators and a plurality of driving target members driven by the plurality of hydraulic actuators. The work device 104 has a configuration in which three driving target members (a boom 111, an arm 112, and a bucket 113) are coupled in series with each other. The boom 111 has a proximal end portion thereof rotatably coupled to a front portion of the swing structure 103 via a boom pin. The arm 112 has a proximal end portion thereof rotatably coupled to a distal end portion of the boom 111 via an arm pin. The bucket 113 is rotatably coupled to a distal end portion of the arm 112 via a bucket pin.

The boom 111 is rotationally driven by extending and contracting operations of a boom cylinder 111A as a hydraulic actuator. The arm 112 is rotationally driven by extending and contracting operations of an arm cylinder 112A as a hydraulic actuator. The bucket 113 is rotationally driven by extending and contracting operations of a bucket cylinder 113A as a hydraulic actuator. The hydraulic excavator 10 can perform soil excavation work, leveling work, compaction work for compacting a ground, or the like by operating the work device 104.

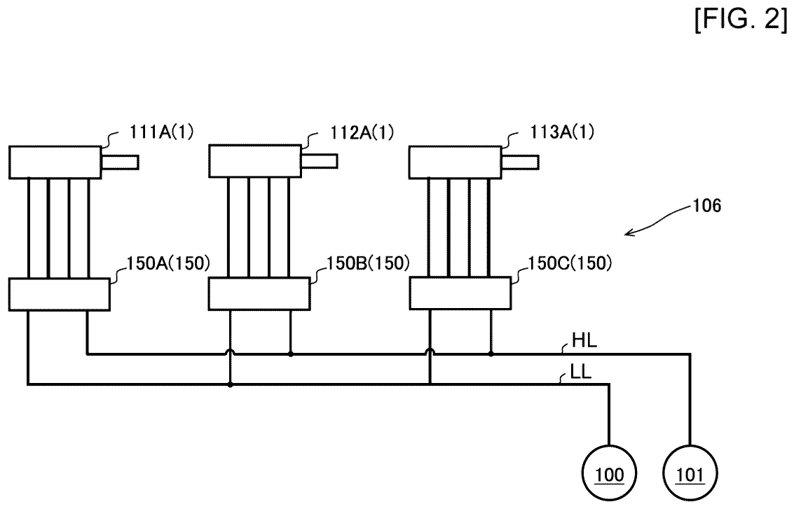

FIG. 2 is a schematic diagram of a hydraulic system 106 provided to the hydraulic excavator 10. Incidentally, FIG. 2 illustrates a configuration for driving the boom cylinder 111A, the arm cylinder 112A, and the bucket cylinder 113A as hydraulic actuators, and does not illustrate a configuration for driving the other hydraulic actuators. Incidentally, the boom cylinder 111A, the arm cylinder 112A, and the bucket cylinder 113A each have a similar configuration, and will therefore hereinafter be collectively described also as hydraulic cylinders 1.

As illustrated in FIG. 2, the hydraulic system 106 includes: a first hydraulic fluid source 101 that supplies hydraulic operating fluid to a high pressure line HL; a second hydraulic fluid source 100 that supplies the hydraulic operating fluid to a low pressure line LL; and a plurality of the hydraulic cylinders 1 (the boom cylinder 111A, the arm cylinder 112A, and the bucket cylinder 113A) driven by the hydraulic operating fluid (working fluid) delivered from the first hydraulic fluid source 101 and the second hydraulic fluid source 100. In addition, the hydraulic system 106 includes: a boom control valve unit 150A that controls a flow of the hydraulic operating fluid supplied from the first hydraulic fluid source 101 and the second hydraulic fluid source 100 to the boom cylinder 111A; an arm control valve unit 150B that controls a flow of the hydraulic operating fluid supplied from the first hydraulic fluid source 101 and the second hydraulic fluid source 100 to the arm cylinder 112A; and a bucket control valve unit 150C that controls a flow of the hydraulic operating fluid supplied from the first hydraulic fluid source 101 and the second hydraulic fluid source 100 to the bucket cylinder 113A. Incidentally, the boom control valve unit 150A, the arm control valve unit 150B, and the bucket control valve unit 150C each have a similar configuration, and will therefore hereinafter be collectively described also as control valve units 150.

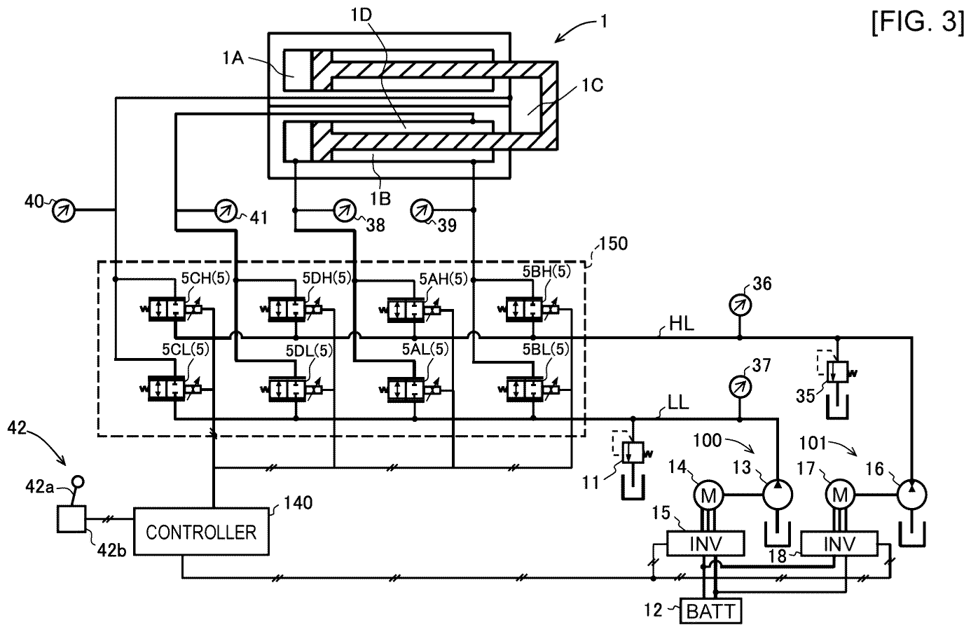

FIG. 3 is a configuration diagram of the hydraulic system 106 according to the first embodiment. FIG. 3 illustrates details of a hydraulic cylinder 1, a control valve unit 150, the first hydraulic fluid source 101, and the second hydraulic fluid source 100. FIG. 3 illustrates a configuration for driving one of the plurality of hydraulic cylinders 1 (for example, the boom cylinder 111A), and does not illustrate a configuration for driving the other hydraulic actuators.

As illustrated in FIG. 3, the hydraulic cylinder 1 is a multi-chamber cylinder having four chambers (a first chamber 1A, a second chamber 1B, a third chamber 1C, and a fourth chamber 1D). The first chamber 1A and the third chamber 1C generate, by a rise in pressure, a cylinder thrust in a direction of extending the hydraulic cylinder 1. The second chamber 1B and the fourth chamber 1D generate, by a rise in pressure, a cylinder thrust in a direction of contracting the hydraulic cylinder 1.

The first hydraulic fluid source 101 includes: a first hydraulic pump 16; a first electrically driven motor 17 that drives the first hydraulic pump 16; and a first inverter 18 that converts direct-current power from a battery 12 into alternating-current power, and supplies the alternating-current power to the first electrically driven motor 17. The second hydraulic fluid source 100 includes: a second hydraulic pump 13; a second electrically driven motor 14 that drives the second hydraulic pump 13; and a second inverter 15 that converts direct-current power from the battery 12 into alternating-current power, and supplies the alternating-current power to the second electrically driven motor 14.

The first hydraulic pump 16 and the second hydraulic pump 13 are a fixed displacement hydraulic pump whose displacement (displacement volume) is fixed. The first hydraulic pump 16 is a pump motor, and has a pump function of sucking the hydraulic operating fluid stored in a tank, and delivering the hydraulic operating fluid to the high pressure line HL, and has a motor function of rotating in an opposite direction from a rotational direction at a time of the delivery due to the hydraulic operating fluid supplied thereto. The second hydraulic pump 13 has only a pump function of sucking the hydraulic operating fluid stored in the tank, and delivering the hydraulic operating fluid to the low pressure line LL.

The first electrically driven motor 17 is a first power source that drives the first hydraulic pump 16. The second electrically driven motor 14 is a second power source that drives the second hydraulic pump 13. The first inverter 18 controls the first electrically driven motor 17 on the basis of a control command from the controller 140. The second inverter 15 controls the second electrically driven motor 14 on the basis of a control command from the controller 140. The battery 12 is a storage device including a storage element such as a lithium ion secondary battery.

The control valve unit 150 includes: four high pressure control valves 5AH, 5BH, 5CH, and 5DH that control communication and interruption between the high pressure line HL and the four chambers 1A, 1B, 1C, and 1D; and four low-pressure control valves 5AL, 5BL, 5CL, and 5DL that control communication and interruption between the low pressure line LL and the four chambers 1A, 1B, 1C, and 1D. The high pressure control valves 5AH, 5BH, 5CH, and 5DH and the low-pressure control valves 5AL, 5BL, 5CL, and 5DL are a solenoid proportional valve whose opening area is controlled by a current output from the controller 140. The high pressure control valves 5AH, 5BH, 5CH, and 5DH and the low-pressure control valves 5AL, 5BL, 5CL, and 5DL each have a similar configuration, and will therefore hereinafter be collectively described also as solenoid proportional valves 5. A solenoid proportional valve 5 is closed when a control signal is off (when a standby current is flowing or when no current is flowing). The opening area of the solenoid proportional valve 5 is adjusted according to the amplitude of a control current when the control signal is on (when the control current is flowing). Incidentally, the solenoid proportional valves 5 are not limited to the normally closed type, but may be of a normally open type.

The high pressure control valve 5AH is provided to a hydraulic line that connects the first hydraulic pump 16 and the first chamber 1A to each other. The high pressure control valve 5AH controls communication and interruption between the high pressure line HL and the first chamber 1A. The high pressure control valve 5BH is provided to a hydraulic line that connects the first hydraulic pump 16 and the second chamber 1B to each other. The high pressure control valve 5BH controls communication and interruption between the high pressure line HL and the second chamber 1B. The high pressure control valve 5CH is provided to a hydraulic line that connects the first hydraulic pump 16 and the third chamber 1C to each other. The high pressure control valve 5CH controls communication and interruption between the high pressure line HL and the third chamber 1C. The high pressure control valve 5DH is provided to a hydraulic line that connects the first hydraulic pump 16 and the fourth chamber 1D to each other. The high pressure control valve 5DH controls communication and interruption between the high pressure line HL and the fourth chamber 1D.

The low-pressure control valve 5AL is provided to a hydraulic line that connects the second hydraulic pump 13 and the first chamber 1A to each other. The low-pressure control valve 5AL controls communication and interruption between the low pressure line LL and the first chamber 1A. The low-pressure control valve 5BL is provided to a hydraulic line that connects the second hydraulic pump 13 and the second chamber 1B to each other. The low-pressure control valve 5BL controls communication and interruption between the low pressure line LL and the second chamber 1B. The low-pressure control valve 5CL is provided to a hydraulic line that connects the second hydraulic pump 13 and the third chamber 1C to each other. The low-pressure control valve 5CL controls communication and interruption between the low pressure line LL and the third chamber 1C. The low-pressure control valve 5DL is provided to a hydraulic line that connects the second hydraulic pump 13 and the fourth chamber 1D to each other. The low-pressure control valve 5DL controls communication and interruption between the low pressure line LL and the fourth chamber 1D.

The high pressure line HL is provided with a first relief valve (pressure control valve) 35 that defines a maximum pressure of the high pressure line HL. The low pressure line LL is provided with a second relief valve (pressure control valve) 11 that defines a maximum pressure of the low pressure line LL. The maximum pressure of the high pressure line HL defined by the first relief valve 35 is higher than the maximum pressure of the low pressure line LL defined by the second relief valve 11.

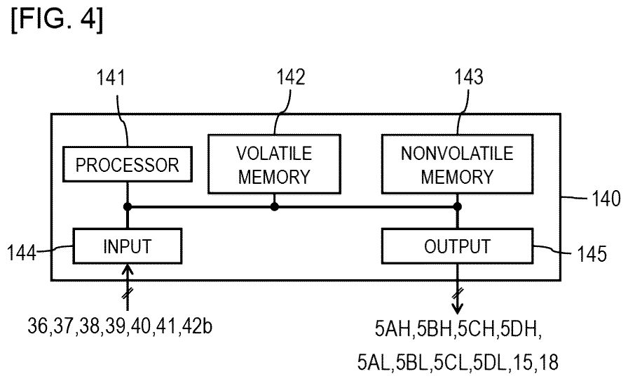

FIG. 4 is a diagram of a hardware configuration of the controller 140. As illustrated in FIG. 4, the controller 140 is constituted by a computer including a processor 141 such as a CPU (Central Processing Unit) or an MPU (Micro Processing Unit), a volatile memory (storage device) 142 referred to as what is called a RAM (Random Access Memory), a nonvolatile memory (storage device) 143 such as a ROM (Read Only Memory), a flash memory, and a hard disk drive, an input interface 144, an output interface 145, and other peripheral circuitry. Incidentally, the controller 140 may be constituted by one computer, or may be constituted by a plurality of computers.

The nonvolatile memory 143 stores a program that can execute various kinds of computations. That is, the nonvolatile memory 143 is a storage medium from which the program for implementing functions of the present embodiment is readable. The processor 141 is a processing device that expands the program stored in the nonvolatile memory 143 into the volatile memory 142, and executes the program by computation. The processor 141 subjects data taken in from the input interface 144, the volatile memory 142, and the nonvolatile memory 143 to predetermined computation processing according to the program.

The input interface 144 converts signals input from respective sensors (36, 37, 38, 39, 40, 41, and 42b) or the like into data that can be subjected to computation in the processor 141. The output interface 145 generates signals for output according to a result of the computation in the processor 141, and outputs the signals to the control valves (5AH, 5BH, 5CH, 5DH, 5AL, 5BL, 5CL, and 5DL) and the inverters (15 and 18) or the like.

As illustrated in FIG. 3, the controller 140 is connected to an operation device 42 for operating the hydraulic cylinder 1. The operation device 42 is an operation device that gives instructions for the operation of the driving target member (for example, the boom 111), that is, the operation of the hydraulic cylinder 1 according to operation by the operator. The operation device 42 includes a control lever (operating member) 42a capable of tilting operation and an operation amount sensor 42b that senses an operation amount (operation angle) of the control lever 42a, and outputs the sensed signal to the controller 140.

The controller 140 is connected with the first inverter 18 and the second inverter 15. The first inverter 18 and the second inverter 15 control the first electrically driven motor 17 and the second electrically driven motor 14 such that actual rotational speeds of the first electrically driven motor 17 and the second electrically driven motor 14 become target rotational speeds set by the controller 140.

The controller 140 is connected with a first delivery pressure sensor 36, a second delivery pressure sensor 37, a first pressure sensor 38, a second pressure sensor 39, a third pressure sensor 40, and a fourth pressure sensor 41. The first delivery pressure sensor 36 senses the delivery pressure of the first hydraulic pump 16, that is, the pressure of the hydraulic operating fluid in the high pressure line HL. The second delivery pressure sensor 37 senses the delivery pressure of the second hydraulic pump 13, that is, the pressure of the hydraulic operating fluid in the low pressure line LL. The first pressure sensor 38 senses the pressure of the hydraulic operating fluid within the first chamber 1A. The second pressure sensor 39 senses the pressure of the hydraulic operating fluid within the second chamber 1B. The third pressure sensor 40 senses the pressure of the hydraulic operating fluid within the third chamber 1C. The fourth pressure sensor 41 senses the pressure of the hydraulic operating fluid within the fourth chamber 1D.

Operation principles of the hydraulic cylinder (multi-chamber cylinder) 1 will be described. The thrust of the hydraulic cylinder 1 can be adjusted by changing the pressure acting on each of the chambers 1A to 1D. Sixteen patterns of cylinder thrusts can be generated by making each of the chambers 1A to 1D communicate with the high pressure line HL or the low pressure line LL.

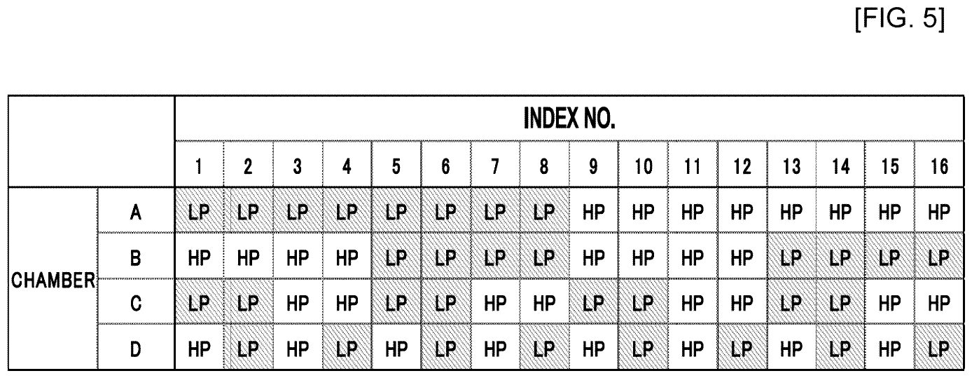

FIG. 5 is an index table of assistance in explaining sixteen patterns of connections of the hydraulic cylinder (multi-chamber cylinder) 1. A to D in the index table correspond to the chambers 1A to 1D of the hydraulic cylinder 1. There are index Nos. of 1 to 16, which each indicate which chambers to connect to the high pressure line HL or the low pressure line LL. For example, an index No. of 10 indicates connection of the first chamber 1A and the second chamber 1B to the high pressure line HL and connection of the third chamber 1C and the fourth chamber 1D to the low pressure line LL. Thus, the sixteen patterns of cylinder thrusts can be obtained by changing the pattern of connection of each of the chambers 1A to 1D to the hydraulic line (HL, LL). Hence, a desired operation can be performed by selecting an appropriate pattern according to a load.

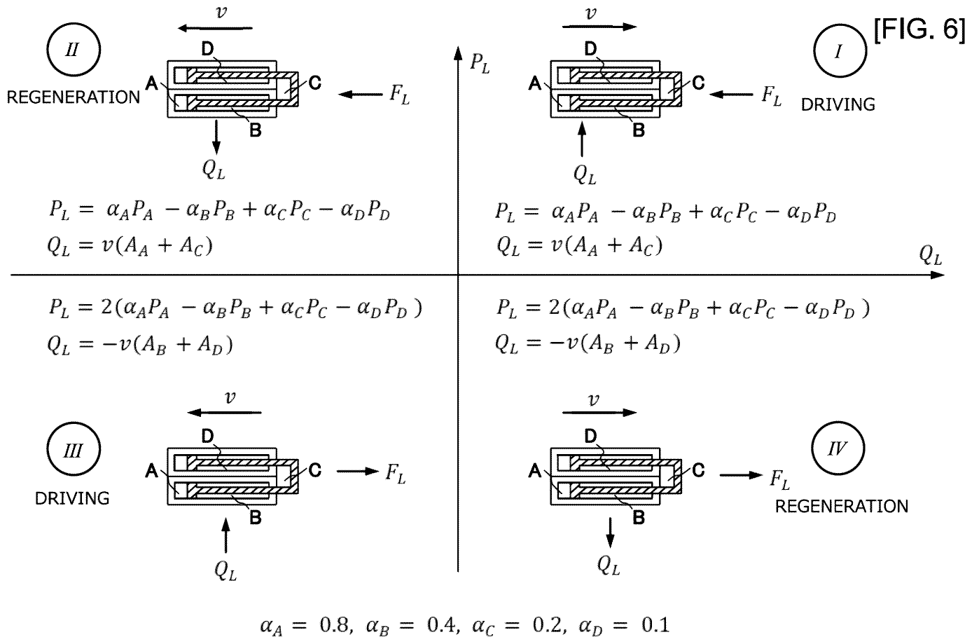

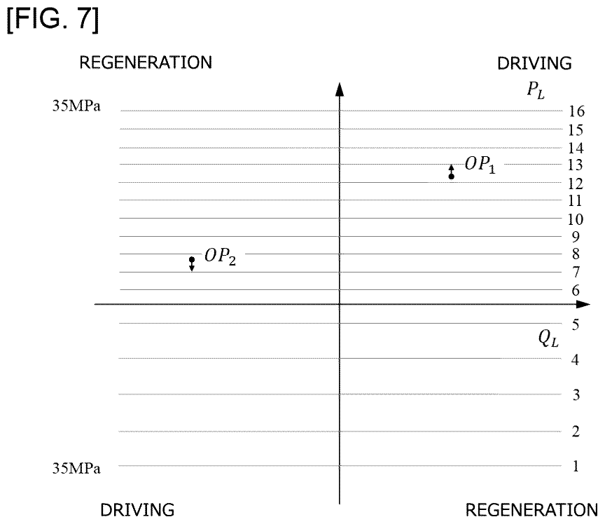

Next, in order to obtain a characteristic diagram (FIG. 7) of the hydraulic cylinder (multi-chamber cylinder) 1 which characteristic diagram will be described later, relation between a load pressure and a load flow rate of the hydraulic cylinder 1 is defined as follows. FIG. 6 is a diagram illustrating the relation between the load pressure and the load flow rate of the hydraulic cylinder 1. FIG. 6 represents the state of the hydraulic cylinder 1 by a four-quadrant matrix according to the operation direction of the hydraulic cylinder 1 and the direction of an acting load. A first quadrant represents a driving state in which the hydraulic cylinder 1 is operated in an extending direction against the load, and a second quadrant represents a regenerative state in which the acting direction of the load and the operation direction are the same. In addition, the second quadrant represents a state in which the hydraulic cylinder 1 operates in a contracting direction. Similarly, a third quadrant represents a driving state in which the hydraulic cylinder 1 is operated in the contracting direction against the load, and a fourth quadrant represents a regenerative state in which the acting direction of the load and the operation direction are the same. In addition, the fourth quadrant represents a state in which the hydraulic cylinder 1 operates in the extending direction.

The relation between the load pressure P_{L} and the load flow rate Q_{L} is defined on the four-quadrant matrix as follows. The load pressure P_{L} is a pressure acting on the hydraulic cylinder 1, and is determined according to the load acting on the hydraulic cylinder 1. The load pressure P_{L} of the hydraulic cylinder 1 is obtained from relation between the pressures of the respective chambers 1A to 1D and the area of pressure receiving surfaces of a rod of the hydraulic cylinder 1 on which surfaces the pressures of the respective chambers 1A to 1D act. Incidentally, in the following, the first to fourth chambers 1A to 1D will be collectively described also as pressure receiving chambers.

The load pressure P_{L} needs to be obtained in consideration of an area ratio between the respective pressure receiving surfaces of the pressure receiving chambers. The area ratio between the pressure receiving surfaces of the respective pressure receiving chambers of the hydraulic cylinder 1 according to the present embodiment is as in (Equation 1) below.

[Expression 1]

A_{A}:A_{B}:A_{C}:A_{D}=8:4:2:1 (Equation 1)

Here, A_{A} is the area of the pressure receiving surface of the first chamber 1A, A_{B} is the area of the pressure receiving surface of the second chamber 1B, A_{C} is the area of the pressure receiving surface of the third chamber 1C, and A_{D} is the area of the pressure receiving surface of the fourth chamber 1D.

The load pressure P_{L} of the hydraulic cylinder 1 in the first quadrant and the second quadrant is expressed as in (Equation 2) below when consideration is given to the above-described area ratio. The load pressure P_{L} of the hydraulic cylinder 1 in the third quadrant and the fourth quadrant is expressed as in (Equation 3) below when consideration is given to the above-described area ratio.

[Expression 2]

P_{L}=α_{A}P_{A}−α_{B}P_{B}+α_{C}P_{C}−α_{D}P_{D} (Equation 2)

[Expression 3]

P_{L}=2(α_{A}P_{A}−α_{B}P_{B}+α_{C}P_{C}−α_{D}P_{D}) (Equation 3)

Here, α_{A} is a coefficient corresponding to the area A_{A} of the pressure receiving surface of the first chamber 1A, and the value of α_{A} is 0.8. P_{A} is the pressure of the hydraulic operating fluid within the first chamber 1A. α_{B} is a coefficient corresponding to the area A_{B} of the pressure receiving surface of the second chamber 1B, and the value of α_{B} is 0.4. P_{B} is the pressure of the hydraulic operating fluid within the second chamber 1B. α_{C} is a coefficient corresponding to the area A_{C} of the pressure receiving surface of the third chamber 1C, and the value of dc is 0.2. P_{C} is the pressure of the hydraulic operating fluid within the third chamber 1C. α_{D} is a coefficient corresponding to the area A_{D} of the pressure receiving surface of the fourth chamber 1D, and the value of α_{D} is 0.1. P_{D} is the pressure of the hydraulic operating fluid within the fourth chamber 1D. Incidentally, the coefficients α_{A}, α_{B}, α_{C}, and α_{D} of the area ratio will be collectively described also as coefficients α.

In the case of the first quadrant, for example, pressure receiving chambers on a meter-in side are the first chamber 1A and the third chamber 1C, and pressure receiving chambers on a meter-out side are the second chamber 1B and the fourth chamber 1D. When the pressure of the pressure receiving chambers on the meter-in side is 10 [MPa], and the pressure of the pressure receiving chambers on the meter-out side is 0 [MPa], the load pressure P_{L} is 10 [MPa].

The load flow rate Q_{L} of the hydraulic cylinder 1 in the first quadrant and the second quadrant is expressed as in (Equation 4) below. The load flow rate Q_{L} of the hydraulic cylinder 1 in the third quadrant and the fourth quadrant is expressed as in (Equation 5) below.

[Expression 4]

Q_{L}=v(A_{A}+A_{C}) (Equation 4)

[Expression 5]

Q_{L}==v(A_{B}+A_{D}) (Equation 5)

The load flow rate Q_{L} is defined as a flow rate on the meter-in side in the first quadrant and the third quadrant as a drive side, and is defined as a flow rate on the meter-out side in the second quadrant and the fourth quadrant as a regenerative side. v is the operation speed (cylinder speed) of the hydraulic cylinder 1. An extension speed as an operation speed when the hydraulic cylinder 1 extends is expressed by a positive value. A contraction speed as an operation speed when the hydraulic cylinder 1 contracts is expressed by a negative value. Therefore, a flow rate on the meter-in side is expressed by a positive value, and a flow rate on the meter-out side is expressed by a negative value. Incidentally, the cylinder speed v is a target speed computed by the controller 140 on the basis of the operation amount of the lever.

The characteristic diagram of the hydraulic cylinder (multi-chamber cylinder) 1 illustrated in FIG. 7 is obtained when the load pressure P_{L} and the load flow rate Q_{L} of the hydraulic cylinder 1 are defined as illustrated in FIG. 6. In FIG. 7, an axis of abscissas indicates the load flow rate Q_{L}, and an axis of ordinates indicates the load pressure P_{L}. As in FIG. 6, the characteristic diagram illustrated in FIG. 7 is represented by a four-quadrant matrix. Respective lines of numbers 1 to 16 indicate characteristics corresponding to the index Nos. of the index table illustrated in FIG. 5. According to the present embodiment, sixteen different cylinder thrusts can be generated by changing the pattern of connection of each of the pressure receiving chambers (1A to 1D) to the hydraulic line (HL, LL) (which pattern will hereinafter be described also as a connection pattern). The controller 140 selects an optimum connection pattern according to the state (quadrant) of the hydraulic cylinder 1 and the load. It is thereby possible to reduce a pressure loss that occurs when the hydraulic cylinder 1 is operated.

When the load pressure P_{L} and the load flow rate Q_{L} of the hydraulic cylinder 1 are at OP₁ in the first quadrant (driving state), for example, the controller 140 selects the index No. 13. That is, a characteristic line that is closest to a present state and indicates a higher load pressure than in the present state is selected. It is thereby possible to drive the hydraulic cylinder 1 efficiently while suppressing the occurrence of a pressure loss. The pressure loss is increased if the controller 140 selects the index No. 16. In addition, the hydraulic cylinder 1 cannot be operated if the index No. 12 or lower No. is selected.

When the load pressure P_{L} and the load flow rate Q_{L} of the hydraulic cylinder 1 are at OP2 in the second quadrant (regenerative state), for example, the controller 140 selects the index No. 7. That is, a characteristic line that is closest to the present state and indicates a lower load pressure than in the present state is selected. It is thereby possible to regenerate energy. The above are the basic operation principles of the multi-chamber cylinder.

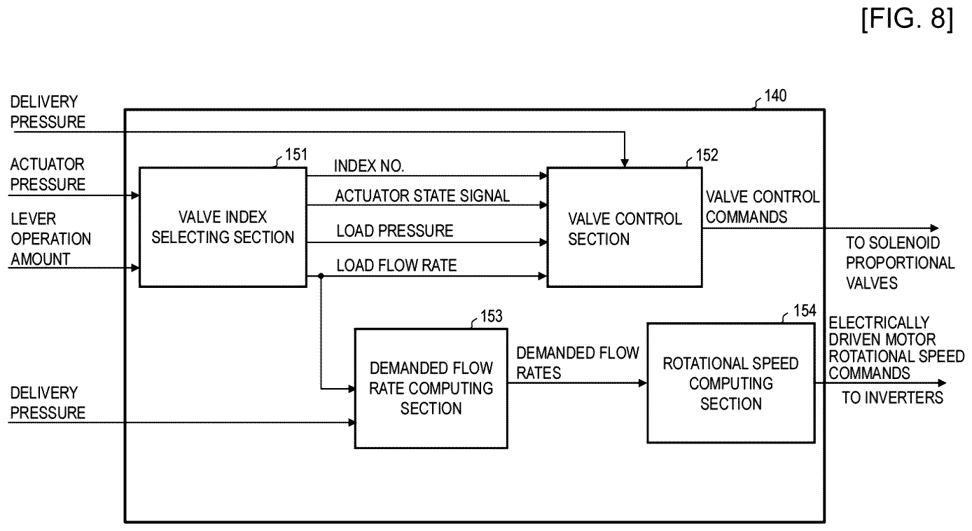

Functions of the controller 140 will be described with reference to FIG. 8. FIG. 8 is a functional block diagram of the controller 140. As illustrated in FIG. 8, the controller 140 functions as a valve index selecting section 151, a valve control section 152, a demanded flow rate computing section 153, and a rotational speed computing section 154 by executing the program stored in the nonvolatile memory 143. The controller 140 controls the four high pressure control valves 5AH, 5BH, 5CH, and 5DH and the four low-pressure control valves 5AL, 5BL, 5CL, and 5DL constituting the control valve unit 150, on the basis of sensing results of the pressure sensors 38 to 41, the operation amount sensor 42b, and the first delivery pressure sensor 36. In addition, the controller 140 controls the rotational speed of the first electrically driven motor 17 on the basis of the sensing results of the pressure sensors 38 to 41 and the operation amount sensor 42b. Further, the controller 140 controls the rotational speed of the second electrically driven motor 14 on the basis of a sensing result of the second delivery pressure sensor 37.

The valve index selecting section 151 selects an index No. on the basis of the pressures of the respective pressure receiving chambers sensed by the pressure sensors 38 to 41 (which pressures will hereinafter be described also as actuator pressures) and the operation amount of the control lever 42a sensed by the operation amount sensor 42b (which operation amount will hereinafter be referred to as a lever operation amount).

The valve index selecting section 151 computes the load pressure P_{L} by (Equation 1) or (Equation 2) in order to identify the state of the hydraulic cylinder 1. The valve index selecting section 151 identifies to which of the quadrants of the four-quadrant matrix the state of the hydraulic cylinder 1 belongs from the load pressure P_{L} and the lever operation amount. The valve index selecting section 151 outputs an actuator state signal indicating the identified state (quadrant). When the load pressure is positive, and lever operation is an operation of extending the hydraulic cylinder 1, the valve index selecting section 151 determines that the state of the hydraulic cylinder 1 is the state of the first quadrant. When the load pressure is positive, and the lever operation is an operation of contracting the hydraulic cylinder 1, the valve index selecting section 151 determines that the state of the hydraulic cylinder 1 is the state of the second quadrant. When the load pressure is negative, and the lever operation is an operation of contracting the hydraulic cylinder 1, the valve index selecting section 151 determines that the state of the hydraulic cylinder 1 is the state of the third quadrant. When the load pressure is negative, and the lever operation is an operation of extending the hydraulic cylinder 1, the valve index selecting section 151 determines that the state of the hydraulic cylinder 1 is the state of the fourth quadrant.

The valve index selecting section 151 computes the load pressure P_{L} and the load flow rate Q_{L} of the actuator on the basis of the identified state of the hydraulic cylinder 1 and the equations of the load pressure P_{L} and the load flow rate Q_{L} corresponding to the state of the hydraulic cylinder 1 described with reference to FIG. 6 and FIG. 7. The valve index selecting section 151 selects the index No. of a characteristic line closest to the computed load pressure P_{L} (line of a number 1 to 16 illustrated in FIG. 7). The valve index selecting section 151 selects the index No. for each of the boom cylinder 111A, the arm cylinder 112A, and the bucket cylinder 113A, and outputs the selected index No.

The valve index selecting section 151 outputs the load pressure P_{L} and the load flow rate Q_{L} computed on the basis of the equations corresponding to the state of the hydraulic cylinder 1.

The valve control section 152 illustrated in FIG. 8 generates a valve control command on the basis of the index No., the actuator state signal, the load pressure, and the load flow rate output from the valve index selecting section 151, and outputs the valve control command to a solenoid proportional valve 5 as a control target.

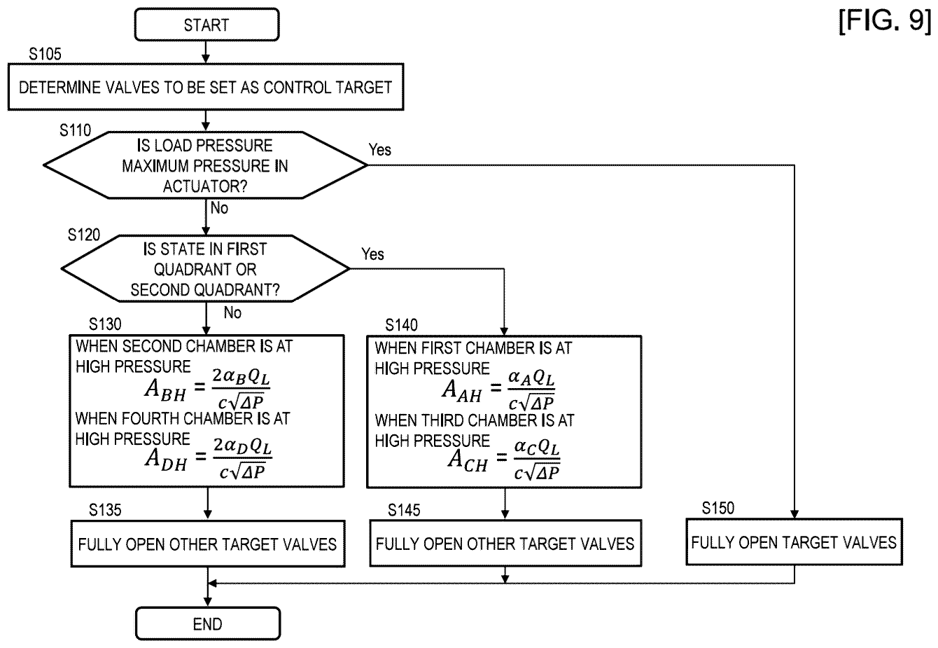

A flow of processing of valve control by the valve control section 152 will be described with reference to FIG. 9. The processing illustrated in FIG. 9 is started by turning on an ignition switch (not illustrated) of the hydraulic excavator 10 (that is, key-on), and is repeatedly performed in a predetermined control cycle. In the following, processing on the solenoid proportional valves 5 constituting the boom control valve unit 150A that controls the boom cylinder 111A will be described as an example. However, valve control is similarly performed also on the solenoid proportional valves 5 constituting the arm control valve unit 150B and the bucket control valve unit 150C.

In step S105, the valve control section 152 refers to the index table (see FIG. 5), and determines solenoid proportional valves 5 to be set as a control target on the basis of the index No. selected by the valve index selecting section 151. As will be described later, the solenoid proportional valves 5 set as a control target are controlled to be fully open, or are controlled to have a predetermined target opening area. Incidentally, the solenoid proportional valves 5 not set as the control target are maintained in a fully closed state.

In step S110, the valve control section 152 determines whether or not the load pressure P_{L} computed in the valve index selecting section 151 is a maximum of the load pressure of the hydraulic actuator. When it is determined that the load pressure P_{L} is the maximum of the load pressure of the hydraulic actuator, the processing proceeds to step S150. When it is determined that the load pressure P_{L} is not the maximum of the load pressure of the hydraulic actuator, the processing proceeds to step S120.

In step S150, the valve control section 152 fully opens the solenoid proportional valves 5 set as a control target. The processing illustrated in the flowchart of FIG. 9 in the present computation cycle is then ended. Such control enables driving of the hydraulic cylinder 1 having a highest load pressure while suppressing a pressure loss. Incidentally, a flow rate supplied to the hydraulic cylinder 1 is controlled by the rotational speed of the electrically driven motor to be described later.

In step S120, the valve control section 152 determines whether or not the state of the hydraulic cylinder 1 is the state of the first quadrant or the second quadrant on the basis of the actuator state signal. When it is determined that the state of the hydraulic cylinder 1 is the state of the first quadrant or the second quadrant, the processing proceeds to step S140. When it is determined that the state of the hydraulic cylinder 1 is the state of the third quadrant or the fourth quadrant, the processing proceeds to step S130.

Step S130 and step S140 perform flow rate control to control the hydraulic cylinder 1 to a desired speed. Basically, a flow rate on a high pressure side needs to be controlled in order to control the speed of the hydraulic cylinder 1. A reason therefor is that the high pressure side controls the thrust or brake force of the hydraulic cylinder 1, and a low pressure side has a very little effect on the thrust or the brake force. Incidentally, when the solenoid proportional valves 5 connecting the low pressure line LL to the pressure receiving chambers of the hydraulic cylinder 1 are selected as a control target, the solenoid proportional valves 5 are controlled to be fully open. Because the flow rate on the high pressure side needs to be controlled in order to control the speed of the hydraulic cylinder 1, when the pressure receiving chambers of the hydraulic cylinder 1 communicate with the high pressure line HL, the opening areas of the solenoid proportional valves 5 connected to the pressure receiving chambers need to be controlled.

From the above, in the case of the first quadrant, only the opening areas of solenoid proportional valves 5 connected to the high pressure line HL among the solenoid proportional valves 5 connected to the first chamber 1A and the third chamber 1C having a meter-in flow rate are controlled. In the case of the second quadrant, only the opening areas of solenoid proportional valves 5 connected to the high pressure line HL among the solenoid proportional valves 5 connected to the first chamber 1A and the third chamber 1C having a meter-out flow rate are controlled. In the case of the third quadrant, only the opening areas of solenoid proportional valves 5 connected to the high pressure line HL among the solenoid proportional valves 5 connected to the second chamber 1B and the fourth chamber 1D having a meter-in flow rate are controlled. In the case of the fourth quadrant, only the opening areas of solenoid proportional valves 5 connected to the high pressure line HL among the solenoid proportional valves 5 connected to the second chamber 1B and the fourth chamber 1D having a meter-out flow rate are controlled. In the following, the processing contents of steps S140, S145, S130, and S135 will be concretely described.

In step S140, the valve control section 152 refers to the index table (see FIG. 5), and determines whether or not the hydraulic lines connected to the first chamber 1A and the third chamber 1C are the high pressure line HL on the basis of the index No. selected by the valve index selecting section 151. When determining that the hydraulic line connected to the first chamber 1A is the high pressure line HL, the valve control section 152 computes a target opening area A_{AH} of the high pressure control valve 5AH connecting the first chamber 1A and the high pressure line HL to each other by (Equation 6) below.

$$[ Expression 6 ]$$

$${A}_{AH} = \frac{{α}_{A} {Q}_{L}}{c \sqrt{Δ P}} \qquad ( Equation 6 )$$

Here, c is a flow rate coefficient, and ΔP is a differential pressure across the high pressure control valve 5AH. The differential pressure ΔP across the high pressure control valve 5AH is obtained by subtracting the pressure of the first chamber 1A sensed by the pressure sensor 38 from the pressure of the high pressure line HL sensed by the first delivery pressure sensor 36. The valve control section 152 outputs a valve control command (control current) to the high pressure control valve 5AH such that the opening area of the high pressure control valve 5AH becomes the computed target opening area A_{AH}. Incidentally, when determining that the hydraulic line connected to the first chamber 1A is the low pressure line LL, the valve control section 152 outputs a valve control command for fully opening the low-pressure control valve 5AL to the low-pressure control valve 5AL.

Similarly, when determining that the hydraulic line connected to the third chamber 1C is the high pressure line HL, the valve control section 152 computes a target opening area A_{CH} of the high pressure control valve 5CH connecting the third chamber 1C and the high pressure line HL to each other by (Equation 7) below.

$$[ Expression 7 ]$$

$${A}_{CH} = \frac{{α}_{C} {Q}_{L}}{c \sqrt{Δ P}} \qquad ( Equation 7 )$$

Here, c is a flow rate coefficient, and ΔP is a differential pressure across the high pressure control valve 5CH. The differential pressure ΔP across the high pressure control valve 5CH is obtained by subtracting the pressure of the third chamber 1C sensed by the pressure sensor 40 from the pressure of the high pressure line HL sensed by the first delivery pressure sensor 36. The valve control section 152 outputs a valve control command (control current) to the high pressure control valve 5CH such that the opening area of the high pressure control valve 5CH becomes the computed target opening area A_{CH}. Incidentally, when determining that the hydraulic line connected to the third chamber 1C is the low pressure line LL, the valve control section 152 outputs a valve control command for fully opening the low-pressure control valve 5CL to the low-pressure control valve 5CL.

In next step S145, the valve control section 152 outputs valve control commands for fully opening the other solenoid proportional valves 5 as a control target to the solenoid proportional valves 5. That is, the valve control section 152 outputs a valve control command for fully opening the solenoid proportional valve 5 selected as a control target among the high pressure control valve 5BH and the low-pressure control valve 5BL connected to the second chamber 1B to the solenoid proportional valve 5. In addition, the valve control section 152 outputs a valve control command for fully opening the solenoid proportional valve 5 selected as a control target among the high pressure control valve 5DH and the low-pressure control valve 5DL connected to the fourth chamber 1D to the solenoid proportional valve 5. When the processing of step S145 is ended, the processing illustrated in the flowchart of FIG. 9 in the present computation cycle is ended.

In step S130, the valve control section 152 refers to the index table (see FIG. 5), and determines whether or not the hydraulic lines connected to the second chamber 1B and the fourth chamber 1D are the high pressure line HL on the basis of the index No. selected by the valve index selecting section 151. When determining that the hydraulic line connected to the second chamber 1B is the high pressure line HL, the valve control section 152 computes a target opening area A_{BH} of the high pressure control valve 5BH connecting the second chamber 1B and the high pressure line HL to each other by (Equation 8) below.

$$[ Expression 8 ]$$

$${A}_{BH} = \frac{2 {α}_{B} {Q}_{L}}{c \sqrt{Δ P}} \qquad ( Equation 8 )$$

Here, c is a flow rate coefficient, and ΔP is a differential pressure across the high pressure control valve 5BH. The differential pressure ΔP across the high pressure control valve 5BH is obtained by subtracting the pressure of the second chamber 1B sensed by the pressure sensor 39 from the pressure of the high pressure line HL sensed by the first delivery pressure sensor 36. The valve control section 152 outputs a valve control command (control current) to the high pressure control valve 5BH such that the opening area of the high pressure control valve 5BH becomes the computed target opening area A_{BH}. Incidentally, when determining that the hydraulic line connected to the second chamber 1B is the low pressure line LL, the valve control section 152 outputs a valve control command for fully opening the low-pressure control valve 5BL to the low-pressure control valve 5BL.

Similarly, when determining that the hydraulic line connected to the fourth chamber 1D is the high pressure line HL, the valve control section 152 computes a target opening area A_{DH} of the high pressure control valve 5DH connecting the fourth chamber 1D and the high pressure line HL to each other by (Equation 9) below.

$$[ Expression 9 ]$$

$${A}_{DH} = \frac{2 {α}_{D} {Q}_{L}}{c \sqrt{Δ P}} \qquad ( Equation 9 )$$

Here, c is a flow rate coefficient, and ΔP is a differential pressure across the high pressure control valve 5DH. The differential pressure ΔP across the high pressure control valve 5DH is obtained by subtracting the pressure of the fourth chamber 1D sensed by the pressure sensor 41 from the pressure of the high pressure line HL sensed by the first delivery pressure sensor 36. The valve control section 152 outputs a valve control command (control current) to the high pressure control valve 5DH such that the opening area of the high pressure control valve 5DH becomes the computed target opening area A_{DH}. Incidentally, when determining that the hydraulic line connected to the fourth chamber 1D is the low pressure line LL, the valve control section 152 outputs a valve control command for fully opening the low-pressure control valve 5DL to the low-pressure control valve 5DL.

In next step S135, the valve control section 152 outputs valve control commands for fully opening the other solenoid proportional valves 5 as a control target to the solenoid proportional valves 5. That is, the valve control section 152 outputs a valve control command for fully opening the solenoid proportional valve 5 selected as a control target among the high pressure control valve 5AH and the low-pressure control valve 5AL connected to the first chamber 1A to the solenoid proportional valve 5. In addition, the valve control section 152 outputs a valve control command for fully opening the solenoid proportional valve 5 selected as a control target among the high pressure control valve 5CH and the low-pressure control valve 5CL connected to the third chamber 1C to the solenoid proportional valve 5. When the processing of step S135 is ended, the processing illustrated in the flowchart of FIG. 9 in the present computation cycle is ended.

As described above, the processing illustrated in the flowchart of FIG. 9 is performed on not only the boom control valve unit 150A but also each of the arm control valve unit 150B and the bucket control valve unit 150C. It is thus possible to implement an operation of the hydraulic cylinder 1 according to a lever operation appropriately by controlling each of the boom control valve unit 150A, the arm control valve unit 150B, and the bucket control valve unit 150C.

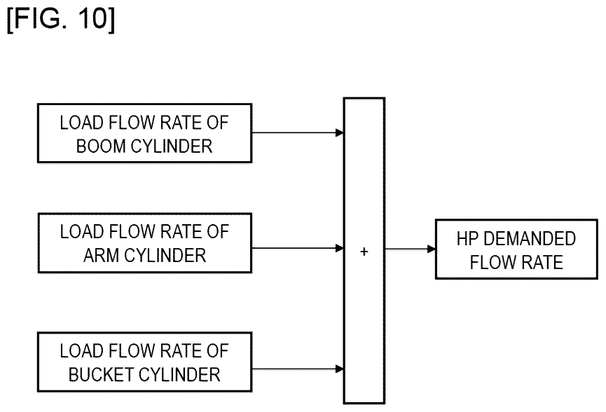

Processing of computing an HP demanded flow rate by the demanded flow rate computing section 153 in FIG. 8 will be described with reference to FIG. 10. The HP demanded flow rate is a flow rate demanded of the first hydraulic pump 16. When the HP demanded flow rate is a positive value, the hydraulic operating fluid is delivered from the first hydraulic pump 16. When the HP demanded flow rate is a negative value, the hydraulic operating fluid is sucked into the first hydraulic pump 16. In this case, the first hydraulic pump 16 performs a regenerative operation. As illustrated in FIG. 10, the demanded flow rate computing section 153 computes a sum total of the load flow rate of the boom cylinder 111A, the load flow rate of the arm cylinder 112A, and the load flow rate of the bucket cylinder 113A as the HP demanded flow rate, and outputs the HP demanded flow rate.

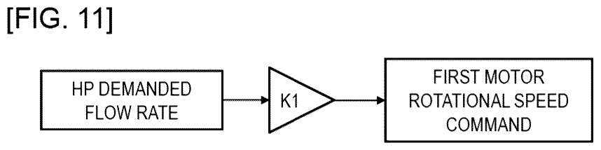

Processing of computing a target rotational speed of the first electrically driven motor 17 by the rotational speed computing section 154 in FIG. 8 will be described with reference to FIG. 11. As illustrated in FIG. 11, the rotational speed computing section 154 computes the target rotational speed by multiplying the HP demanded flow rate computed by the demanded flow rate computing section 153 by a gain K1. The rotational speed computing section 154 outputs a first motor rotational speed command as a command for making the rotational speed of the first electrically driven motor 17 the target rotational speed. The gain K1 is a constant (conversion coefficient) defining relation between the HP demanded flow rate of the first hydraulic pump 16 and the rotational speed of the first electrically driven motor 17 (rotational speed of the first hydraulic pump 16), and is determined on the basis of the displacement (displacement volume) of the first hydraulic pump 16.

The first motor rotational speed command is input to the first inverter 18. The first inverter 18 controls the rotational speed of the first electrically driven motor 17 on the basis of the first motor rotational speed command such that the first electrically driven motor 17 rotates at the target rotational speed.

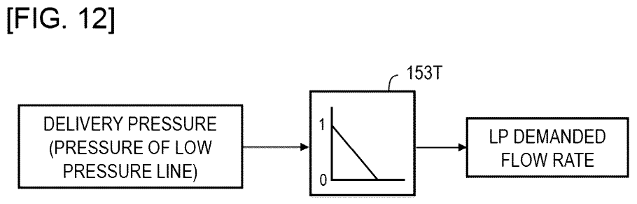

Processing of computing an LP demanded flow rate by the demanded flow rate computing section 153 in FIG. 8 will be described with reference to FIG. 12. The LP demanded flow rate is a flow rate demanded of the second hydraulic pump 13. As illustrated in FIG. 12, the demanded flow rate computing section 153 has a demanded flow rate table 153T defining relation between the pressure of the low pressure line LL and the LP demanded flow rate. Characteristics defined by the demanded flow rate table 153T are as follows. When the pressure of the low pressure line LL is 0 (that is, a tank pressure), the LP demanded flow rate is 1, which represents a maximum flow rate. In addition, the LP demanded flow rate decreases as the pressure of the low pressure line LL increases. Further, when the pressure of the low pressure line LL becomes equal to or higher than a predetermined value, the LP demanded flow rate is 0, which represents a minimum flow rate. The demanded flow rate table 153T is stored in the nonvolatile memory 143 in advance.

The demanded flow rate computing section 153 refers to the demanded flow rate table 153T, computes the LP demanded flow rate on the basis of the pressure of the low pressure line LL sensed by the second delivery pressure sensor 37, and outputs the LP demanded flow rate.

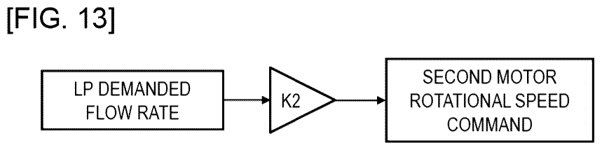

Processing of computing a target rotational speed of the second electrically driven motor 14 by the rotational speed computing section 154 in FIG. 8 will be described with reference to FIG. 13. As illustrated in FIG. 13, the rotational speed computing section 154 computes the target rotational speed by multiplying the LP demanded flow rate computed by the demanded flow rate computing section 153 by a gain K2. The rotational speed computing section 154 outputs a second motor rotational speed command as a command for making the rotational speed of the second electrically driven motor 14 the target rotational speed. The gain K2 is a constant (conversion coefficient) defining relation between the LP demanded flow rate of the second hydraulic pump 13 and the rotational speed of the second electrically driven motor 14 (rotational speed of the second hydraulic pump 13), and is determined on the basis of the displacement volume of the second hydraulic pump 13.

The second motor rotational speed command is input to the second inverter 15. The second inverter 15 controls the rotational speed of the second electrically driven motor 14 on the basis of the second motor rotational speed command such that the second electrically driven motor 14 rotates at the target rotational speed. Consequently, a certain pressure is established in the low pressure line LL, and the low pressure line LL can be prevented from having a negative pressure when the first hydraulic pump 16 sucks the oil in a regenerative state. Incidentally, in the present embodiment, the flow rate of the second hydraulic pump 13 is smoothly controlled according to the pressure of the low pressure line LL. It is therefore possible to suppress the occurrence of noise as compared with a case where the second hydraulic pump 13 and the second electrically driven motor 14 are subjected to ON/OFF control with a predetermined pressure as a boundary.

As described above, the controller 140 according to the first embodiment can identify the state of the hydraulic cylinder 1 according to the lever operation amount and the pressure of each pressure receiving chamber of the hydraulic cylinder 1, reduce a pressure loss by controlling the control valve unit 150 appropriately according to the load on the hydraulic cylinder 1, and thus drive the hydraulic cylinder 1 efficiently.

The above-described embodiment produces the following actions and effects.

(1) The hydraulic excavator (work machine) 10 includes: the machine body 105; the work device 104 attached to the machine body 105; the first hydraulic pump 16 that supplies the hydraulic operating fluid to the high pressure line HL; the first electrically driven motor (first power source) 17 that drives the first hydraulic pump 16; the second hydraulic pump 13 that supplies the hydraulic operating fluid to the low pressure line LL; the second electrically driven motor (second power source) 14 that drives the second hydraulic pump 13; the hydraulic cylinder 1 that has the four chambers 1A, 1B, 1C, and 1D, and drives the work device 104 by being driven by the hydraulic operating fluid delivered from the first hydraulic pump 16 and the second hydraulic pump 13; the four high pressure control valves 5AH, 5BH, 5CH, and 5DH that control communication and interruption between the high pressure line HL and the four chambers 1A, 1B, 1C, and 1D of the hydraulic cylinder 1; the four low-pressure control valves 5AL, 5BL, 5CL, and 5DL that control communication and interruption between the low pressure line LL and the four chambers 1A, 1B, 1C, and 1D of the hydraulic cylinder 1; the four pressure sensors 38, 39, 40, and 41 that sense the pressures of the four chambers 1A, 1B, 1C, and 1D; the operation device 42 that operates the hydraulic cylinder 1; the operation amount sensor 42b that senses the operation amount of the operation device 42; and the controller 140 that controls the four high pressure control valves 5AH, 5BH, 5CH, and 5DH and the four low-pressure control valves 5AL, 5BL, 5CL, and 5DL on the basis of sensing results of the pressure sensors 38, 39, 40, and 41 and the operation amount sensor 42b. The controller 140 controls the rotational speed of the first electrically driven motor 17 on the basis of the sensing results of the pressure sensors 38 to 41 and the operation amount sensor 42b.

Though not illustrated in the figure, in a configuration in which a high pressure accumulator is connected to the high pressure line HL and a low pressure accumulator is connected to the low pressure line LL without the first electrically driven motor 17 and the second electrically driven motor 14 being provided as a first comparative example of the present embodiment, the pressure of the high pressure line HL is held constant by the high pressure accumulator. Therefore, a large pressure loss occurs at all times when the hydraulic actuator is operated. On the other hand, in the present embodiment, the pressure of the high pressure line HL can be changed by controlling the rotational speed of the first electrically driven motor 17. Therefore, a pressure loss occurring in the control valve unit 150 can be reduced by reducing the pressure of the high pressure line HL when a high pressure is not demanded of the high pressure line HL. That is, according to the present embodiment, the hydraulic cylinder 1 can be controlled efficiently. An operating time of the hydraulic excavator 10 can therefore be lengthened.

In addition, the first comparative example necessitates high-capacity accumulators in order to hold the pressure of the high pressure line HL and the pressure of the low pressure line LL constant. The container of the high pressure accumulator in particular is desired to have high durability, so that the hydraulic excavator 10 may be increased in cost. By contrast, in the present embodiment, the high pressure line HL does not need to be provided with the high pressure accumulator, so that the cost of the hydraulic excavator 10 can be reduced.

In addition, though not illustrated in the figure, in a case where an engine is provided as a power source in place of an electrically driven motor as a second comparative example of the present embodiment, there is a fear of degradation in responsiveness when the rotational speed of the hydraulic pump is controlled. Therefore, in the second comparative example, it is difficult to change the pressures of the high pressure line HL and the low pressure line LL to target pressures quickly, so that there is a fear of degradation in operability of the hydraulic cylinder 1. On the other hand, in the present embodiment, the pressures of the high pressure line HL and the low pressure line LL can be quickly controlled to the target pressures by the electrically driven motors, and therefore the hydraulic cylinder 1 excels in operability.

(2) The hydraulic excavator 10 includes the second delivery pressure sensor (low pressure line pressure sensor) 37 that senses the delivery pressure of the second hydraulic pump 32 (pressure of the low pressure line LL). The controller 140 controls the rotational speed of the second electrically driven motor (second power source) 14 on the basis of a sensing result of the second delivery pressure sensor 37. According to this configuration, a certain pressure can be established in the low pressure line LL. As a result, the low pressure line LL can be prevented from having a negative pressure when the first hydraulic pump 16 sucks the oil in a regenerative state.

### Second Embodiment

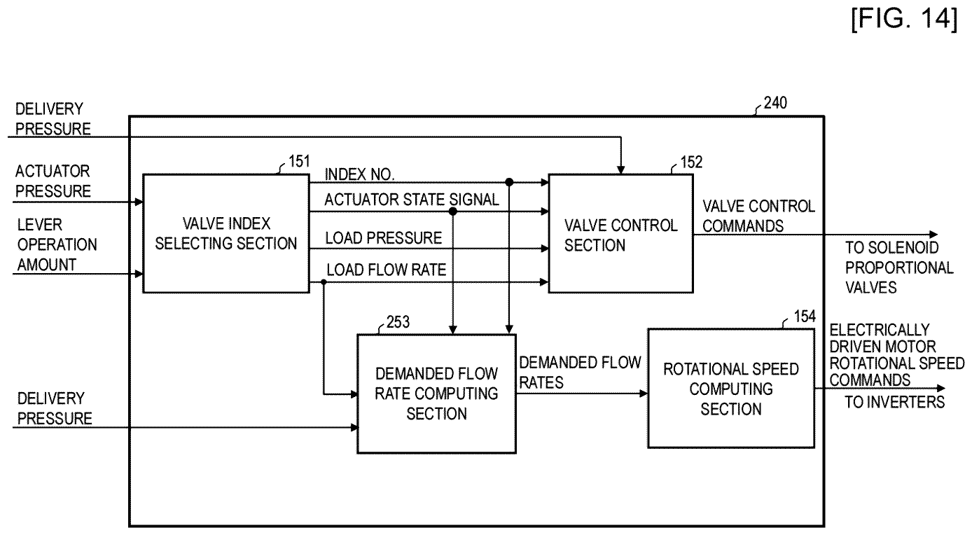

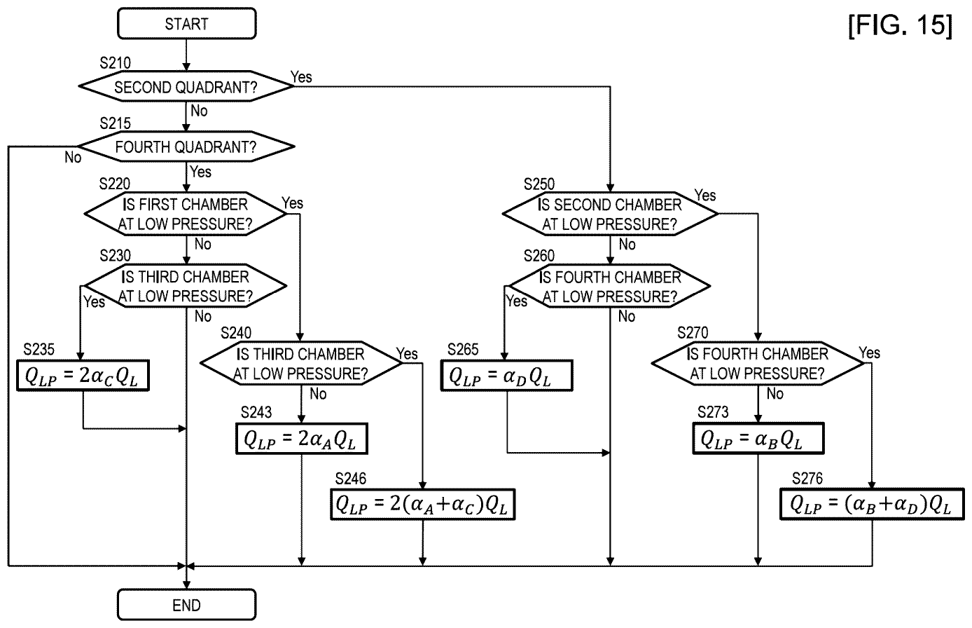

A hydraulic excavator 10 according to a second embodiment of the present invention will be described with reference to FIG. 14 and FIG. 15. Incidentally, configurations identical or corresponding to configurations described in the first embodiment are identified by the same reference numerals, and differences will be mainly described.

FIG. 14 is a functional block diagram of a controller 240 according to the second embodiment. In the second embodiment, a method of computing the LP demanded flow rate by a demanded flow rate computing section 253 is different from that of the first embodiment. Incidentally, the other processing is similar to that of the first embodiment, and therefore description thereof will be omitted. As illustrated in FIG. 14, the index No. and the actuator state signal output from the valve index selecting section 151 are input to the demanded flow rate computing section 253. The demanded flow rate computing section 253 computes a suction flow rate on the basis of the index No., the actuator state signal, and the load flow rate Q_{L}.

A flow of processing of computing the suction flow rate by the demanded flow rate computing section 253 will be described with reference to FIG. 15. The processing illustrated in FIG. 15 is started by turning on the ignition switch (not illustrated) of the hydraulic excavator 10 (that is, key-on), and is repeatedly performed in a predetermined control cycle. In the following, processing of computing the suction flow rate of the boom cylinder 111A on the basis of a state of connection between the boom cylinder 111A and the low pressure line LL will be described as an example. However, the following processing is also similarly performed: processing of computing the suction flow rate of the arm cylinder 112A on the basis of a state of connection between the arm cylinder 112A and the low pressure line LL and processing of computing the suction flow rate of the bucket cylinder 113A on the basis of a state of connection between the bucket cylinder 113A and the low pressure line LL.

In step S210, the demanded flow rate computing section 253 determines whether or not the state of the hydraulic cylinder 1 is the state of the second quadrant on the basis of the actuator state signal. When it is determined that the state of the hydraulic cylinder 1 is the state of the second quadrant, the processing proceeds to step S250. When it is determined that the state of the hydraulic cylinder 1 is not the state of the second quadrant, the processing proceeds to step S215.

In step S250, the demanded flow rate computing section 253 refers to the index table (see FIG. 5), and determines whether or not the hydraulic line connected to the second chamber 1B is the low pressure line LL on the basis of the index No. selected by the valve index selecting section 151. When it is determined that the hydraulic line connected to the second chamber 1B is the low pressure line LL, the processing proceeds to step S270. When it is determined that the hydraulic line connected to the second chamber 1B is the high pressure line HL, the processing proceeds to step S260.

In steps S260 and S270, the demanded flow rate computing section 253 refers to the index table (see FIG. 5), and determines whether or not the hydraulic line connected to the fourth chamber 1D is the low pressure line LL on the basis of the index No. selected by the valve index selecting section 151. When it is determined in step S260 that the hydraulic line connected to the fourth chamber 1D is the low pressure line LL, the processing proceeds to step S265. When it is determined in step S260 that the hydraulic line connected to the fourth chamber 1D is the high pressure line HL, it is determined that there is no suction flow rate. The processing illustrated in the flowchart of FIG. 15 in the present computation cycle is then ended. When it is determined in step S270 that the hydraulic line connected to the fourth chamber 1D is the low pressure line LL, the processing proceeds to step S276. When it is determined in step S270 that the hydraulic line connected to the fourth chamber 1D is the high pressure line HL, the processing proceeds to step S273.

In step S265, the demanded flow rate computing section 253 determines that only the fourth chamber 1D is a suction side chamber, and computes the suction flow rate Q_{LP} of the hydraulic cylinder 1 by (Equation 10) below on the basis of the coefficient op indicating the area ratio of the pressure receiving surface of the fourth chamber 1D and the load flow rate Q_{L}.

[Expression 10]

Q_{LP}=α_{D}Q_{L} (Equation 10)

In step S273, the demanded flow rate computing section 253 determines that only the second chamber 1B is a suction side chamber, and computes the suction flow rate Q_{LP} of the hydraulic cylinder 1 by (Equation 11) below on the basis of the coefficient α_{B} indicating the area ratio of the pressure receiving surface of the second chamber 1B and the load flow rate Q_{L}.

[Expression 11]

Q_{LP}=α_{B}Q_{L} (Equation 11)

In step S276, the demanded flow rate computing section 253 determines that both of the second chamber 1B and the fourth chamber 1D are suction side chambers, and computes the suction flow rate Q_{LP} Of the hydraulic cylinder 1 by (Equation 12) below on the basis of the coefficient α_{B} indicating the area ratio of the pressure receiving surface of the second chamber 1B, the coefficient op indicating the area ratio of the pressure receiving surface of the fourth chamber 1D, and the load flow rate Q_{L}.

[Expression 12]

Q_{LP}=(α_{B}+α_{D})Q_{L} (Equation 12)

That the state of the hydraulic cylinder 1 is the state of the second quadrant means that the hydraulic cylinder 1 is in a regenerative state of being pressed and contracted by an external force, as described above. Therefore, the second chamber 1B and the fourth chamber 1D each need to suck the oil when connected to the low pressure line LL. Therefore, the demanded flow rate computing section 253 determines that the chambers connected to the low pressure line LL are suction side chambers, and computes the suction flow rate Q_{LP} by multiplying the load flow rate Or by the coefficients α of the area ratios.

In step S215, the demanded flow rate computing section 253 determines whether or not the state of the hydraulic cylinder 1 is the state of the fourth quadrant on the basis of the actuator state signal. When it is determined that the state of the hydraulic cylinder 1 is the state of the fourth quadrant, the processing proceeds to step S220. When it is determined that the state of the hydraulic cylinder 1 is not the state of the fourth quadrant, it is determined that the state of the hydraulic cylinder 1 is a driving state, and that there is no suction flow rate. The processing illustrated in the flowchart of FIG. 15 in the present computation cycle is then ended.

In step S220, the demanded flow rate computing section 253 refers to the index table (see FIG. 5), and determines whether or not the hydraulic line connected to the first chamber 1A is the low pressure line LL on the basis of the index No. selected by the valve index selecting section 151. When it is determined that the hydraulic line connected to the first chamber 1A is the low pressure line LL, the processing proceeds to step S240. When it is determined that the hydraulic line connected to the first chamber 1A is the high pressure line HL, the processing proceeds to step S230.

In steps S230 and S240, the demanded flow rate computing section 253 refers to the index table (see FIG. 5), and determines whether or not the hydraulic line connected to the third chamber 1C is the low pressure line LL on the basis of the index No. selected by the valve index selecting section 151. When it is determined in step S230 that the hydraulic line connected to the third chamber 1C is the low pressure line LL, the processing proceeds to step S235. When it is determined in step S230 that the hydraulic line connected to the third chamber 1C is the high pressure line HL, it is determined that there is no suction flow rate. The processing illustrated in the flowchart of FIG. 15 in the present computation cycle is then ended. When it is determined in step S240 that the hydraulic line connected to the third chamber 1C is the low pressure line LL, the processing proceeds to step S246. When it is determined in step S240 that the hydraulic line connected to the third chamber 1C is the high pressure line HL, the processing proceeds to step S243.

In step S235, the demanded flow rate computing section 253 determines that only the third chamber 1C is a suction side chamber, and computes the suction flow rate Q_{LP} of the hydraulic cylinder 1 by (Equation 13) below on the basis of the coefficient dc indicating the area ratio of the pressure receiving surface of the third chamber 1C and the load flow rate Q_{L}.

[Expression 13]

Q_{LP}=2α_{C}Q_{L} (Equation 13)

In step S243, the demanded flow rate computing section 253 determines that only the first chamber 1A is a suction side chamber, and computes the suction flow rate Q_{LP} of the hydraulic cylinder 1 by (Equation 14) below on the basis of the coefficient da indicating the area ratio of the pressure receiving surface of the first chamber 1A and the load flow rate Q_{L}.

[Expression 14]

Q_{LP}=2α_{A}Q_{L} (Equation 14)

In step S246, the demanded flow rate computing section 253 determines that both of the first chamber 1A and the third chamber 1C are suction side chambers, and computes the suction flow rate Qp of the hydraulic cylinder 1 by (Equation 15) below on the basis of the coefficient xx indicating the area ratio of the pressure receiving surface of the first chamber 1A, the coefficient oc indicating the area ratio of the pressure receiving surface of the third chamber 1C, and the load flow rate Q_{L}.

[Expression 15]

Q_{LP}=2(α_{A}+α_{C})Q_{L} (Equation 15)

That the state of the hydraulic cylinder 1 is the state of the fourth quadrant means that the hydraulic cylinder 1 is in a regenerative state of being pulled and extended by an external force, as described above. Therefore, the first chamber 1A and the third chamber 1C each need to suck the oil when connected to the low pressure line LL. Therefore, the demanded flow rate computing section 253 determines that the chambers connected to the low pressure line LL are suction side chambers, and computes the suction flow rate Q_{LP} by multiplying the load flow rate Q_{L} by the coefficients α of the area ratios.

The demanded flow rate computing section 253 illustrated in FIG. 14 computes a sum total of the suction flow rate of the boom cylinder 111A, the suction flow rate of the arm cylinder 112A, and the suction flow rate of the bucket cylinder 113A as the LP demanded flow rate, and outputs the LP demanded flow rate. As in the first embodiment, the rotational speed computing section 154 computes the target rotational speed by multiplying the LP demanded flow rate by the gain K2. The rotational speed computing section 154 outputs the second motor rotational speed command as a command for making the rotational speed of the second electrically driven motor 14 the target rotational speed.

As described above, the controller 240 according to the present second embodiment controls the rotational speed of the second electrically driven motor 14 on the basis of the sensing results of the pressure sensors 38 to 41 and the operation amount sensor 42b. According to this configuration, it is possible to supply a necessary flow rate by appropriately controlling the second electrically driven motor 14 such that a negative pressure or the like does not cause cavitation in a state in which the hydraulic cylinder 1 sucks the oil. Further, the present second embodiment can obviate a need for the installation of the second delivery pressure sensor 37.

### Third Embodiment

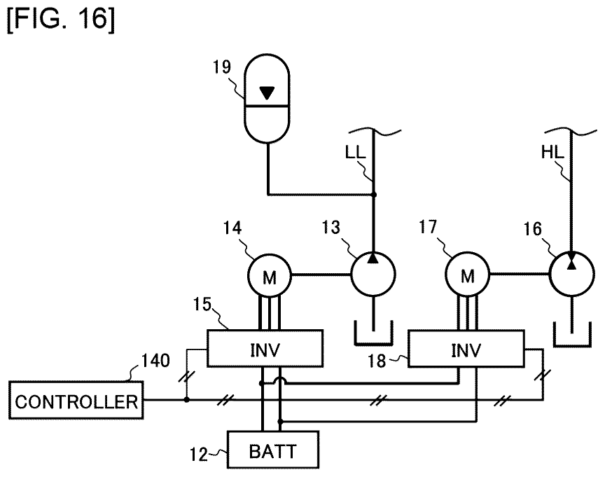

A hydraulic excavator 10 according to a third embodiment of the present invention will be described with reference to FIG. 16. Incidentally, configurations identical or corresponding to configurations described in the first embodiment are identified by the same reference numerals, and differences will be mainly described. FIG. 16 is a diagram illustrating a configuration of hydraulic fluid sources according to the third embodiment.

As illustrated in FIG. 16, the third embodiment is different from the first embodiment in that an accumulator 19 is connected to the low pressure line LL. The accumulator 19 is a pressure accumulating device that can accumulate the hydraulic fluid of the second hydraulic pump 13 when the suction flow rate of the hydraulic cylinder 1 is not necessary.

Thus, the hydraulic excavator 10 according to the present third embodiment further includes the accumulator (pressure accumulating device) 19 connected to the low pressure line LL. It is thereby possible to supply the oil from the accumulator 19 and the second hydraulic pump 13 when a suction flow rate of the hydraulic cylinder 1 is necessary. According to this configuration, the displacement (size) of the second hydraulic pump 13 can be reduced.

### Fourth Embodiment

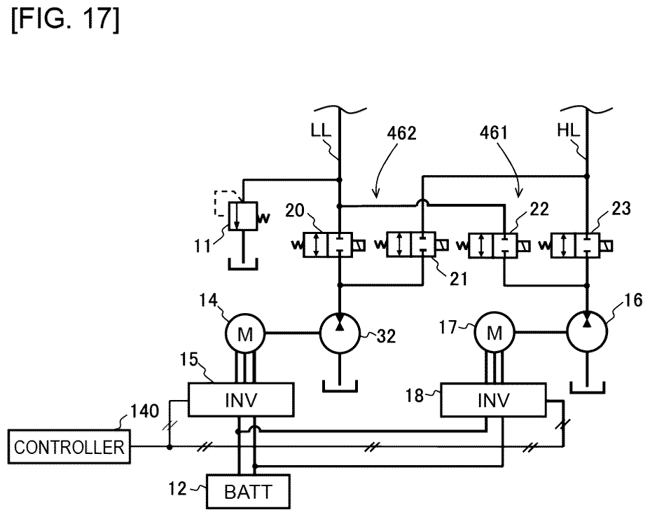

A hydraulic excavator 10 according to a fourth embodiment of the present invention will be described with reference to FIG. 17. Incidentally, configurations identical or corresponding to configurations described in the first embodiment are identified by the same reference numerals, and differences will be mainly described. FIG. 17 is a diagram illustrating a configuration of hydraulic fluid sources according to the fourth embodiment.

As illustrated in FIG. 17, the fourth embodiment is different from the first embodiment in the following respects.

(Difference 1) A second hydraulic pump 32 is a pump motor.

(Difference 2) A first switching device 461 is provided to be able to supply the hydraulic fluid delivered from the first hydraulic pump 16 not only to the high pressure line HL but also to the low pressure line LL.

(Difference 3) A second switching device 462 is provided to be able to supply the hydraulic fluid delivered from the second hydraulic pump 32 not only to the low pressure line LL but also to the high pressure line HL.

The first switching device 461 includes: a solenoid selector valve 23 that can be switched between a communication position for making the first hydraulic pump 16 and the high pressure line HL communicate with each other and an interruption position for interrupting the communication between the first hydraulic pump 16 and the high pressure line HL; and a solenoid selector valve 22 that can be switched between a communication position for making the first hydraulic pump 16 and the low pressure line LL communicate with each other and an interruption position for interrupting the communication between the first hydraulic pump 16 and the low pressure line LL.

The second switching device 462 includes: a solenoid selector valve 21 that can be switched between a communication position for making the second hydraulic pump 32 and the high pressure line HL communicate with each other and an interruption position for interrupting the communication between the second hydraulic pump 32 and the high pressure line HL; and a solenoid selector valve 20 that can be switched between a communication position for making the second hydraulic pump 32 and the low pressure line LL communicate with each other and an interruption position for interrupting the communication between the second hydraulic pump 32 and the low pressure line LL.

Incidentally, the solenoid selector valves 20 to 23 may be a two-position selector valve, or may be a solenoid proportional valve whose opening area is adjusted according to a current supplied to a solenoid.

In the first embodiment, when a large flow rate is expected to be demanded, a hydraulic pump or a hydraulic pump motor having a large displacement needs to be installed. Accordingly, the present fourth embodiment adopts a configuration in which hydraulic pump motors (the first hydraulic pump 16 and the second hydraulic pump 32) are installed for each of the high pressure line HL and the low pressure line LL, and the hydraulic fluids of the respective pump motors are merged with each other.

Thus, the hydraulic excavator 10 according to the fourth embodiment includes: the first switching device 461 capable of controlling communication and interruption between the first hydraulic pump 16 and the high pressure line HL and capable of controlling communication and interruption between the first hydraulic pump 16 and the low pressure line LL; and the second switching device 462 capable of controlling communication and interruption between the second hydraulic pump 32 and the low pressure line LL and capable of controlling communication and interruption between the second hydraulic pump 32 and the high pressure line HL. According to this configuration, the hydraulic operating fluid delivered from the first hydraulic pump 16 and the hydraulic operating fluid delivered from the second hydraulic pump 32 can be merged with each other, and supplied to the hydraulic cylinder 1, so that a displacement per hydraulic pump can be reduced. Incidentally, when not only the first hydraulic pump 16 but also the second hydraulic pump 32 is configured as a pump motor, the second hydraulic pump 32 can be made to perform a regenerative operation. As a result, energy can be recovered more efficiently than in the first embodiment.

### Fifth Embodiment

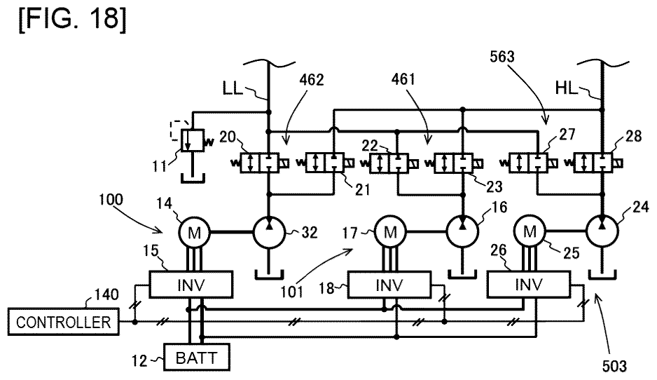

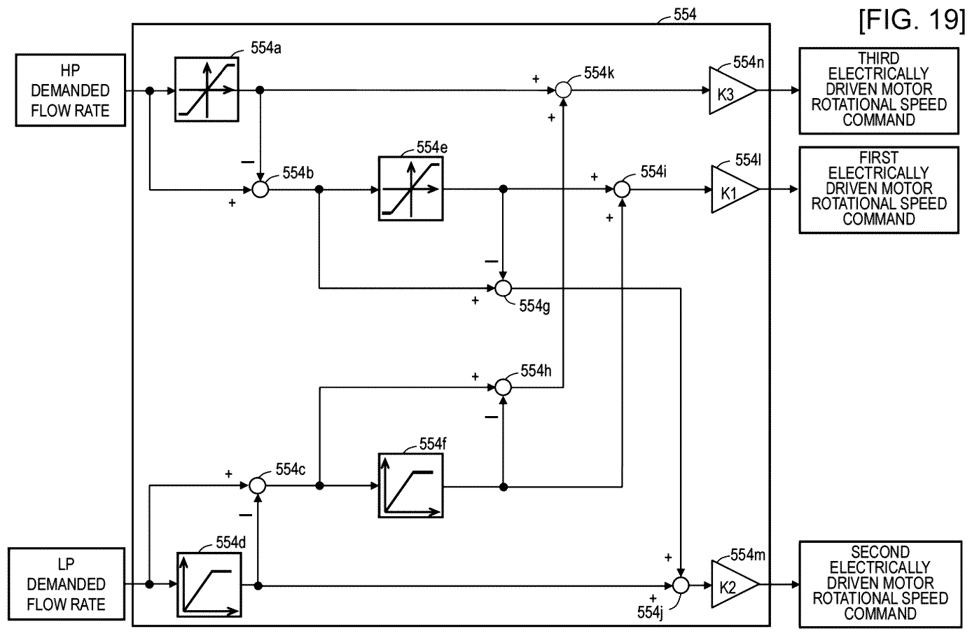

A hydraulic excavator 10 according to a fifth embodiment of the present invention will be described with reference to FIG. 18 and FIG. 19. Incidentally, configurations identical or corresponding to configurations described in the fourth embodiment are identified by the same reference numerals, and differences will be mainly described. FIG. 18 is a diagram illustrating a configuration of hydraulic fluid sources according to the fifth embodiment.

As illustrated in FIG. 18, the fifth embodiment has a configuration obtained by adding a third hydraulic fluid source 503 to the configuration of the fourth embodiment. The third hydraulic fluid source 503 includes: a third hydraulic pump 24 as a pump motor; a third electrically driven motor 25 that drives the third hydraulic pump 24; a third inverter 26 that converts direct-current power from the battery 12 into alternating-current power, and supplies the alternating-current power to the third electrically driven motor 25; and a third switching device 563 capable of making the third hydraulic pump 24 and at least one of the high pressure line HL and the low pressure line LL communicate with each other.

The third switching device 563 includes: a solenoid selector valve 28 that can be switched between a communication position for making the third hydraulic pump 24 and the high pressure line HL communicate with each other and an interruption position for interrupting the communication between the third hydraulic pump 24 and the high pressure line HL; and a solenoid selector valve 27 that can be switched between a communication position for making the third hydraulic pump 24 and the low pressure line LL communicate with each other and an interruption position for interrupting the communication between the third hydraulic pump 24 and the low pressure line LL.

FIG. 19 is a control block diagram of a rotational speed computing section 554 according to the fifth embodiment. As illustrated in FIG. 19, the rotational speed computing section 554 generates a first electrically driven motor rotational speed command, a second electrically driven motor rotational speed command, and a third electrically driven motor rotational speed command on the basis of the HP demanded flow rate and the LP demanded flow rate, and outputs the electrically driven motor rotational speed commands. Incidentally, all of the first hydraulic pump 16, the second hydraulic pump 32, and the third hydraulic pump 24 are pump motors having a same displacement volume.

The rotational speed computing section 554 includes a first function generating section 554a, a second function generating section 554e, a third function generating section 554d, a fourth function generating section 554f, a first subtracting section 554b, a second subtracting section 554g, a third subtracting section 554c, a fourth subtracting section 554h, a first adding section 554i, a second adding section 554j, a third adding section 554k, a first gain multiplying section 554l, a second gain multiplying section 554m, and a third gain multiplying section 554n.

The first function generating section 554a and the second function generating section 554e store an HP pump characteristic table that defines relation between a demanded flow rate and a target flow rate of a hydraulic pump. The first function generating section 554a and the second function generating section 554e each calculate a flow rate that can be handled by one electrically driven motor. Pump characteristics defined by the HP pump characteristic table have a saturation characteristic whose upper limit is cut.

The first function generating section 554a refers to the HP pump characteristic table, and computes an HP target flow rate of the third hydraulic pump 24 with the HP demanded flow rate as an input value. The first subtracting section 554b computes a first HP demanded remaining flow rate by subtracting the HP target flow rate of the third hydraulic pump 24 from the HP demanded flow rate. The second function generating section 554e refers to the HP pump characteristic table, and computes an HP target flow rate of the first hydraulic pump 16 with the first HP demanded remaining flow rate as an input value. The second subtracting section 554g computes an HP target flow rate of the second hydraulic pump 32 (second HP demanded remaining flow rate) by subtracting the HP target flow rate of the first hydraulic pump 16 from the first HP demanded remaining flow rate.

The third function generating section 554d and the fourth function generating section 554f store an LP pump characteristic table that defines relation between a demanded flow rate and a target flow rate of a hydraulic pump. The third function generating section 554d and the fourth function generating section 554f each calculate a flow rate that can be handled by one electrically driven motor. Pump characteristics defined by the LP pump characteristic table have a saturation characteristic whose upper limit is cut.

The third function generating section 554d refers to the LP pump characteristic table, and computes an LP target flow rate of the second hydraulic pump 32 with the LP demanded flow rate as an input value. The third subtracting section 554c computes a first LP demanded remaining flow rate by subtracting the LP target flow rate of the second hydraulic pump 32 from the LP demanded flow rate. The fourth function generating section 554f refers to the LP pump characteristic table, and computes an LP target flow rate of the first hydraulic pump 16 with the first LP demanded remaining flow rate as an input value. The fourth subtracting section 554h computes an LP target flow rate of the third hydraulic pump 24 (second LP demanded remaining flow rate) by subtracting the LP target flow rate of the first hydraulic pump 16 from the first LP demanded remaining flow rate.

The first adding section 554i computes a target flow rate of the first hydraulic pump 16 by adding together the HP target flow rate and LP target flow rate of the first hydraulic pump 16. The first gain multiplying section 554l computes a target rotational speed of the first electrically driven motor 17 by multiplying the target flow rate of the first hydraulic pump 16 by a gain K1. The rotational speed computing section 554 outputs a first motor rotational speed command as a command for making the rotational speed of the first electrically driven motor 17 the target rotational speed.

The second adding section 554j computes a target flow rate of the second hydraulic pump 32 by adding together the HP target flow rate and the LP target flow rate of the second hydraulic pump 32. The second gain multiplying section 554m computes a target rotational speed of the second electrically driven motor 14 by multiplying the target flow rate of the second hydraulic pump 32 by a gain K2. The rotational speed computing section 554 outputs a second motor rotational speed command as a command for making the rotational speed of the second electrically driven motor 14 the target rotational speed.

The third adding section 554k computes a target flow rate of the third hydraulic pump 24 by adding together the HP target flow rate and the LP target flow rate of the third hydraulic pump 24. The third gain multiplying section 554n computes a target rotational speed of the third electrically driven motor 25 by multiplying the target flow rate of the third hydraulic pump 24 by a gain K3. The rotational speed computing section 554 outputs a third motor rotational speed command as a command for making the rotational speed of the third electrically driven motor 25 the target rotational speed.

An example of operation in the present embodiment will be described in the following. Incidentally, the description will be made supposing that a maximum flow rate of each hydraulic pump is 50 [L/min]. When the HP demanded flow rate is equal to or less than 50 [L/min], the HP demanded flow rate is the HP target flow rate of the third hydraulic pump 24 as it is.

When the HP demanded flow rate is 120 [L/min], an upper limit of the output of the first function generating section 554a is cut. The HP target flow rate of the third hydraulic pump 24 consequently becomes 50 [L/min], which can be handled by one hydraulic pump. The first subtracting section 554b computes 70 [L/min], which is a remaining necessary flow rate on the basis of the HP demanded flow rate (120 [L/min]) and the output of the first function generating section 554a (50 [L/min]). An upper limit of the output of the second function generating section 554e is similarly cut. The HP target flow rate of the first hydraulic pump 16 consequently becomes 50 [L/min], which can be handled by one hydraulic pump. The second subtracting section 554g computes 20 [L/min] as a remaining necessary flow rate on the basis of the output (70 [L/min]) of the first subtracting section 554b and the output (50 [L/min]) of the second function generating section 554e, and sets the remaining necessary flow rate as the HP target flow rate of the second hydraulic pump 32.

The LP target flow rates of the respective hydraulic pumps based on the LP demanded flow rate are similarly calculated by the third function generating section 554d, the fourth function generating section 554f, the third subtracting section 554c, and the fourth subtracting section 554h.

Incidentally, it is possible to calculate, as the HP demanded flow rate, both of a demanded flow rate at a time of driving which demanded flow rate is represented by a positive value and a demanded flow rate at a time of regeneration which demanded flow rate is represented by a negative value. On the other hand, the occurrence of a negative pressure needs to be prevented in the low pressure line LL. The LP demanded flow rate therefore assumes a positive value representing a flow rate of sending the oil.

The HP target flow rate and the LP target flow rate calculated for each hydraulic pump are added together in each of the first adding section 554i, the second adding section 554j, the third adding section 554k to compute a final target flow rate of one hydraulic pump.

The present fifth embodiment is configured such that the third electrically driven motor 25 and the third hydraulic pump 24 give priority to the HP demanded flow rate, and such that the second electrically driven motor 14 and the second hydraulic pump 32 give priority to the LP demanded flow rate. That is, such logic is provided that one hydraulic pump is dedicated to either of the above as much as possible to avoid branching.

Incidentally, the solenoid selector valves 20 to 23, 27, and 28 are a solenoid proportional valve whose opening area is adjusted according to a current supplied to a solenoid. The controller 140 controls the opening areas of the solenoid proportional valves constituting the first switching device 461, the second switching device 462, and the third switching device 563, on the basis of the HP target flow rates and the LP target flow rates of the respective hydraulic pumps.

The hydraulic excavator 10 according to the present fifth embodiment includes: the third hydraulic pump 24; the third electrically driven motor (third power source) 25 that drives the third hydraulic pump 24; and the third switching device 563 capable of controlling communication and interruption between the third hydraulic pump 24 and the high pressure line HL and capable of controlling communication and interruption between the third hydraulic pump 24 and the low pressure line LL. The controller 140 controls the rotational speeds of the first electrically driven motor (first power source) 17, the second electrically driven motor (second power source) 14, and the third electrically driven motor (third power source) 25 on the basis of the sensing results of the pressure sensors 38 to 41 and the operation amount sensor 42b. According to this configuration, it is possible to finely adjust the flow rate of the hydraulic operating fluid flowing through the high pressure line HL and the flow rate of the hydraulic operating fluid flowing through the low pressure line LL.

Incidentally, though not illustrated in the figure, four or more hydraulic pumps and four or more power sources may be provided. It is thereby possible to more finely adjust the flow rate of the hydraulic operating fluid flowing through the high pressure line HL and the flow rate of the hydraulic operating fluid flowing through the low pressure line LL.

### Sixth Embodiment

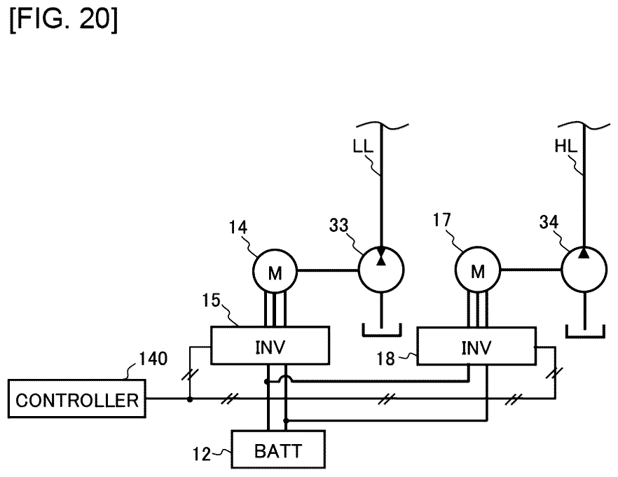

A hydraulic excavator 10 according to a sixth embodiment of the present invention will be described with reference to FIG. 20. Incidentally, configurations identical or corresponding to configurations described in the first embodiment are identified by the same reference numerals, and differences will be mainly described. FIG. 20 is a diagram illustrating a configuration of hydraulic fluid sources according to the sixth embodiment.

As illustrated in FIG. 20, the sixth embodiment is different from the first embodiment in that a first hydraulic pump 34 connected to the high pressure line HL is not a pump motor but a hydraulic pump having only a pump function, and a second hydraulic pump 33 connected to the low pressure line LL is a pump motor having a pump function and a motor function. When the second hydraulic pump 33 connected to the low pressure line LL is thus configured as a pump motor, the hydraulic fluid discharged from the hydraulic cylinder 1 can be recovered. In addition, when the first hydraulic pump 34 is configured as a hydraulic pump having only a pump function rather than a pump motor, it is possible to simplify the configuration and achieve a reduction in cost. A high pressure hydraulic pump motor is more expensive than a low pressure one. Thus, such a configuration can suppress an increase in cost of the hydraulic excavator 10 as a whole.

The following modifications are also within the scope of the present invention. It is possible to combine a configuration illustrated in a modification and a configuration described in a foregoing embodiment with each other, or combine configurations described in foregoing different embodiments with each other.

### MODIFICATIONS

In the foregoing embodiments, description has been made of an example in which the work machines are crawler type hydraulic excavators. However, the present invention is not limited to this. The work machines may be wheel type hydraulic excavators. In addition, the present invention is applicable to various work machines provided with a work device having a plurality of hydraulic cylinders, such as a wheel loader and a crane.

Embodiments of the present invention have been described above. However, the foregoing embodiments merely represent a part of examples of application of the present invention, and are not intended to limit the technical scope of the present invention to specific configurations of the foregoing embodiments.

### DESCRIPTION OF REFERENCE CHARACTERS

1: hydraulic cylinder (multi-chamber cylinder)
1A: first chamber (pressure receiving chamber)
1B: second chamber (pressure receiving chamber)
1C: third chamber (pressure receiving chamber)
1D: fourth chamber (pressure receiving chamber)
5: solenoid proportional valve
5AH, 5BH, 5CH, 5DH: high pressure control valve
5AL, 5BL, 5CL, 5DL: low pressure control valve
10: hydraulic excavator
11: second relief valve
12: battery
13: second hydraulic pump
14: second electrically driven motor (second power source)
15: second inverter
16: first hydraulic pump (pump motor)
17: first electrically driven motor (first power source)
18: first inverter
19: accumulator (pressure accumulating device)
20, 21, 22, 23: solenoid selector valve
24: third hydraulic pump
25: third electrically driven motor (third power source)
26: third inverter
27, 28: solenoid selector valve
32: second hydraulic pump (pump motor)
33: second hydraulic pump (pump motor)
34: first hydraulic pump
35: first relief valve
36: first delivery pressure sensor (high pressure line pressure sensor)
37: second delivery pressure sensor (low pressure line pressure sensor)
38: first pressure sensor (pressure sensor)
39: second pressure sensor (pressure sensor)
40: third pressure sensor (pressure sensor)
41: fourth pressure sensor (pressure sensor)
42: operation device
42a: control lever (operating member)
42b: operation amount sensor
100: second hydraulic fluid source
101: first hydraulic fluid source
102: track structure
102A: travelling motor (hydraulic actuator)
103: swing structure
103A: swing motor (hydraulic actuator)
104: work device
105: machine body
106: hydraulic system
111: boom (driving target member)
111A: boom cylinder (hydraulic cylinder, hydraulic actuator)
112: arm
112A: arm cylinder (hydraulic cylinder, hydraulic actuator)
113: bucket
113A: bucket cylinder (hydraulic cylinder, hydraulic actuator)
118: cab
119: machine room
140: controller
141: processor
142: volatile memory (storage device)
143: nonvolatile memory (storage device)
144: input interface
145: output interface
150: control valve unit
150A: boom control valve unit
150B: arm control valve unit
150C: bucket control valve unit
151: valve index selecting section
152: valve control section
153: demanded flow rate computing section
153T: demanded flow rate table
154: rotational speed computing section
240: controller
253: demanded flow rate computing section
461: first switching device
462: second switching device
503: third hydraulic fluid source
554: rotational speed computing section
563: third switching device
HL: high pressure line
LL: low pressure line

1.-6. (canceled)

7. A work machine comprising:
a machine body;
a work device attached to the machine body;
a first hydraulic pump that supplies hydraulic operating fluid to a high pressure line;
a first power source that drives the first hydraulic pump;
a second hydraulic pump that supplies the hydraulic operating fluid to a low pressure line;
a second power source that drives the second hydraulic pump;
a hydraulic cylinder that has four chambers, and drives the work device by being driven by the hydraulic operating fluid delivered from the first hydraulic pump and the second hydraulic pump;
four high pressure control valves that control communication and interruption between the high pressure line and the four chambers of the hydraulic cylinder;
four low pressure control valves that control communication and interruption between the low pressure line and the four chambers of the hydraulic cylinder;
four pressure sensors that sense pressures of the four chambers;
a low pressure line pressure sensor that senses a pressure of the low pressure line;
an operation device that operates the hydraulic cylinder;
an operation amount sensor that senses an operation amount of the operation device; and
a controller that controls the four high pressure control valves and the four low pressure control valves on a basis of sensing results of the pressure sensors and the operation amount sensor,
the first power source and the second power source being electrically driven motors,
the controller controlling a rotational speed of the electrically driven motor as the first power source on the basis of the sensing result of the operation amount sensor, and controlling a rotational speed of the electrically driven motor as the second power source on a basis of a sensing result of the low pressure line pressure sensor.

8. The work machine according to claim 7, further comprising a pressure accumulating device connected to the low pressure line.

9. The work machine according to claim 7, wherein
the work machine includes
a first switching device capable of controlling communication and interruption between the first hydraulic pump and the high pressure line and capable of controlling communication and interruption between the first hydraulic pump and the low pressure line, and
a second switching device capable of controlling communication and interruption between the second hydraulic pump and the low pressure line and capable of controlling communication and interruption between the second hydraulic pump and the high pressure line.

10. The work machine according to claim 9, wherein
the work machine includes
a third hydraulic pump,
a third power source as an electrically driven motor that drives the third hydraulic pump, and
a third switching device capable of controlling communication and interruption between the third hydraulic pump and the high pressure line and capable of controlling communication and interruption between the third hydraulic pump and the low pressure line, and
the controller controls rotational speeds of the electrically driven motors as the first power source, the second power source, and the third power source on the basis of the sensing results of the pressure sensors and the operation amount sensor.
